(19) United States
(12) Patent Application Publication
(10) Pub. No.: US 2023/0359982 A1
(43) Pub. Date: Nov. 9, 2023

(54) SYSTEM AND METHOD FOR TRACKING WINE IN A WINE-CELLAR AND MONITORING INVENTORY

(71) Applicant: Mehdi Mohseni, Palo Alto, CA (US)

(72) Inventor: Mehdi Mohseni, Palo Alto, CA (US)

(21) Appl. No.: 17/735,333

(22) Filed: May 3, 2022

(51) Int. Cl. G06Q 10/08; G06Q 30/02; G06V 20/60; G06V 30/19

(52) U.S. Cl. CPC G06Q 10/087; G06Q 30/0202; G06Q 30/0278; G06V 20/60; G06V 30/19007

(57) ABSTRACT

A wine bottle tracking system (100, 500) is described herein, comprising: a plurality of wine bottle storage locations (216) within a wine storage area (214); at least one or more wine bottles (218) stored in any of the wine bottle locations; at least one optical detector (202, 502, 504) adapted to generate image information that includes image data (212) of a first wine bottle as it is being stored into, or removed from, the wine bottle storage location, and wherein the at least one optical detector is further adapted to output the image information as a camera output signal (220); at least one processor (206) communicatively coupled to the at least one optical detector; and a memory (208) operatively connected with the at least one processor, wherein the memory stores computer-executable instructions (102, 104, 118) that, when executed by the at least one processor, causes the at least one processor to execute a method (300, 400, 600) that comprises: receiving, via the at least one optical detector, the camera output signal within a wine tracker application executing on the at least one processor; analyzing the camera output signal; and extracting wine information pertaining to the wine stored in the first wine bottle on the basis of the analysis of the camera output signal by the at least one processor and wine tracking application. The systems and methods described herein can further recognize wine bottles and obtain information related to the wine in the wine bottles, and can further predict consumer behavior and/or consumption of wine.

### PRIORITY INFORMATION

The present application (Attorney Docket Number 0439-00003) claims priority as a U.S. Continuation Patent Application filed under 35 U.S.C. § 120 to U.S. National Stage Patent Application Serial Number XX/YYY,YYY, filed on ______, 2021 (Attorney Docket Number 0439-00002). U.S. National Stage Patent Application Serial Number XX/YYY,YYY was filed under 37 C.F.R. § 1.371 to PCT Application No. PCT/US20/67514, which was filed on Dec. 30, 2020 (Attorney Docket Number IPLL 0439-00005). PCT Application No. PCT/US20/67514 claims priority under 35 U.S.C. § 119(e) to U.S. Provisional Patent Application Ser. No. 62/955,383, filed Dec. 30, 2019 (Attorney Docket Number IPLL 0439-00001), the entire contents of all of which are expressly incorporated herein by reference.

### CROSS REFERENCE TO RELATED APPLICATIONS

Related subject matter is disclosed in two co-pending U.S. Non-provisional Patent Applications, Serial No. XX/YYY,WWW (Attorney Docket No. IPLL 0439-00002), filed on September XX, 2021, and Serial No. XX/YYY,WWW (Attorney Docket No. IPLL 0439-00004), filed on September XX, 2021, the entire contents of both of which are expressly incorporated herein by reference.

### BACKGROUND OF THE INVENTION

### Technical Field

The embodiments described herein relate generally to inventory management, and more specifically to systems, methods, and modes for a computer- and network-based wine bottle inventory and storage management system.

### Background Art

Over the last decade or so, the consumption of wine has been generally rising in the United States (see, https://www.wineinstitute.org/resource/statistics/article86). Many people today purport to practice a much healthier lifestyle than those of just fifty years ago, and with the realization that consuming wine, in moderation, can be beneficial to one's health, it is easy to understand the general upward trend in consumption, in conjunction with greater disposable wealth.

With the increased consumption of wine, comes increased sales, and related business practices. That is, even though sales are increasing, retailers can appreciate the necessity to cater to an increasing and sophisticated clientele. Such an environment means that retailers must achieve greater knowledge of their wares, and market their products better. One aspect of such better business practices is inventory management. In addition, inventory management practices can also be used by private owners.

There are least several aspects of inventory management that can reasonably lead to better tracking and management of a wine inventory. One aspect, in regard to the retail situation, is to provide a means to determine and provide to the customer relevant wine information for the bottle, e.g., the brand/winery, region, grape type and varietal, vintage, among other relevant characteristics. Another aspect is to provide a means to identify the bottles stored in the cellar/storage area with the associated wine information; this way, one can search for a particular bottle of wine in the inventory using the wine information. A still further aspect is to provide a means to identify the location of the bottles in the cellar; this way, one can identify the location of the bottle in the inventory by using the wine information.

Currently available wine inventory management systems implement one or more of the above described aspects or functions of wine inventory management manually or semi-automatically. For example, a user can enter detailed wine information into wine inventory management systems manually by filling in fields on paper or on a computer form (stored in a database or memory) based on the details printed on the bottle label. Some advanced wine inventory management systems employ bar code readers and the like to automate this step by scanning the bottle's label using an image scanner/camera. As those of skill in the art can appreciate, bar codes can be generated and printed, and then applied to wine bottles, and can be coded to include numerous types of wine information. An intelligent image scanning system can extract the information from the label image employing methods known to those of skill in the art.

In regard to the second aspect of wine inventory management systems as described above, one example of a traditional semi-automatic process involves identifying wine bottles in the inventory system using a barcode, near-field communication (NFC) tag, and/or radio-frequency identification (RFID) tag. The barcode, NFC, or RFID tags can store relevant wine information for the bottle, e.g., brand/winery, region, grape type and varietal, vintage, etc. and can identify the wine bottle in the inventory system. An NFC or RFID reader uses appropriate technology to read/recover stored information on the tag. Barcode tags can be printed and placed on the bottle. The NFC/RFID tags are also programmed and placed on a bottle (usually at the bottom). By doing so, once the wine information for the bottle is entered into the system and the barcode or NFC/RFID tag is generated, the system can identify the bottle at any point in time by reading the tag. For example, by scanning the bottle when removed from the inventory, the system can update the inventory and remove the bottle from it.

In regard to the third aspect of wine inventory management systems many if not most of currently used methods rely on the users to manually enter the location where the bottle is stored in the cellar. The wine inventory management systems associate a particular location with a particular bottle. By doing so, the wine inventory management systems can provide the user with the location information when a particular bottle is searched for. In more advanced examples, a semi-automatic solution can be employed by tagging the storage locations in the cellar with an NFC/RFID tag or a barcode in advance. A record of the location is generated and stored in the system by scanning the NFC/RFID or barcode and associate it with the bottle during the placement of the bottle.

When looking to retrieve a bottle from the cellar, a combination of the above information can be used to find the bottle and its stored location, by searching through the recorded data. As can be appreciated by those of skill in the art, the placements of tags and labels is costly and time consuming, and a labor-intensive task.

Accordingly, a need has arisen for systems, methods, and modes for a computer- and network-based wine bottle inventory and storage management system.

### SUMMARY

It is an object of the embodiments to substantially solve at least the problems and/or disadvantages discussed above, and to provide at least one or more of the advantages described below.

It is therefore a general aspect of the embodiments to provide systems, methods, and modes for a computer- and network-based wine bottle inventory and storage management system that will obviate or minimize problems of the type previously described.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Further features and advantages of the aspects of the embodiments, as well as the structure and operation of the various embodiments, are described in detail below with reference to the accompanying drawings. It is noted that the aspects of the embodiments are not limited to the specific embodiments described herein. Such embodiments are presented herein for illustrative purposes only. Additional embodiments will be apparent to persons skilled in the relevant art(s) based on the teachings contained herein.

According to a first aspect of the embodiments, a wine bottle tracking system is provided, comprising: a plurality of wine bottle storage locations within a wine storage area; at least one or more wine bottles stored in any of the wine bottle locations; at least one optical detector adapted to generate image information that includes image data of a first wine bottle as it is being stored into, or removed from, the wine bottle storage location, and wherein the at least one optical detector is further adapted to output the image information as a camera output signal; at least one processor communicatively coupled to the at least one optical detector; and a memory operatively connected with the at least one processor, wherein the memory stores computer-executable instructions that, when executed by the at least one processor, causes the at least one processor to execute a method that comprises: receiving, via the at least one optical detector, the camera output signal within a wine tracker application executing on the at least one processor; analyzing the camera output signal; and extracting wine information pertaining to the wine stored in the first wine bottle on the basis of the analysis of the camera output signal by the at least one processor and wine tracking application.

According to the first aspect of the embodiments, the method that is executed by the at least one processor further comprises: extracting wine information from the first wine bottle by processing a label on the first wine bottle.

According to the first aspect of the embodiments, the method that is executed by the at least one processor further comprises: performing optical character recognition processing on the label of the first wine bottle.

According to the first aspect of the embodiments, the method that is executed by the at least one processor further comprises: performing image recognition processing on the label of the first wine bottle.

According to the first aspect of the embodiments, the method that is executed by the at least one processor further comprises: generating a respective wine database record for each bottle of wine that is tracked by the wine bottle tracking system; and storing the wine database record in the memory, wherein the wine database record comprises the wine information.

According to the first aspect of the embodiments, the wine database record includes a plurality of fields comprising at least a wine bottle identification field, a bottle location identification field, and a wine information identification field.

According to the first aspect of the embodiments, the wine bottle identification field comprises a unique alpha-numeric identification for each respective wine bottle analyzed by the wine bottle tracking system, and wherein the bottle location identification field comprises a unique alpha-numeric identification for each respective wine bottle that identifies its unique location within the wine storage area, and wherein the wine information identification field comprises a unique alpha-numeric identification for a respective type of wine that includes a unique set of wine information.

According to the first aspect of the embodiments, the bottle location identification field includes storage location information that uniquely identifies a specific storage location of a respective bottle of wine within the wine storage area.

According to the first aspect of the embodiments, the method that is executed by the at least one processor further comprises: generating a plurality of additional fields in the wine database record, wherein the additional fields include additional wine-related information that is related to the wine stored in the bottle, and further wherein the additional wine-related information can be obtained from one or more of a plurality of sources including commercially available wine information databases.

According to the first aspect of the embodiments, the at least one optical detector comprises at least one of a low-resolution still camera, a high-resolution still camera, a low-resolution video camera, a high-resolution video camera, an infra-red camera, a stereovision camera, and a coherent light transmitter and receiver.

According to a second aspect of the embodiments, a method for tracking one or more wine bottles in a wine bottle storage area is provided, the method comprising: receiving, via at least one optical detector coupled to at least one processor, a camera output signal representing an image of a wine bottle as it enters the wine bottle storage area, at a wine tracker application executing on the at least one processor, the wine tracker application stored in a memory associated with the at least one processor; analyzing the camera output signal; and extracting wine information pertaining to the wine stored in the wine bottle on the basis of the analysis of the camera output signal by the at least one processor and wine tracking application.

According to the second aspect of the embodiments, the step of extracting wine information comprises: extracting wine information from the first wine bottle by performing optical character recognition processing on the label of the first wine bottle.

According to the second aspect of the embodiments, the step of extracting wine information comprises: extracting wine information from the first wine bottle by performing image recognition processing on the label of the first wine bottle.

According to the second aspect of the embodiments, the method further comprises: generating a respective wine database record in the memory associated with the at least one processor for each bottle of wine that is tracked by the wine bottle tracking system; and storing the wine database record in the memory, wherein the wine database record comprises the wine information, and wherein the wine database record includes a plurality of fields comprising at least a wine bottle identification field, a bottle location identification field, and a wine information identification field, and further wherein the wine bottle identification field comprises a unique alpha-numeric identification, wine bottle ID, for each respective wine bottle analyzed by the wine bottle tracking system, and wherein the bottle location identification field comprises a unique alpha-numeric identification, bottle location ID, for each respective wine bottle that identifies its unique location within the wine storage area, and wherein the wine information identification field comprises a unique alpha-numeric identification, wine info ID, for a respective type of wine that includes a unique set of wine information, and further wherein the bottle location identification field includes storage location information that uniquely identifies a specific storage location of a respective bottle of wine within the wine storage area.

According to the second aspect of the embodiments, the method further comprises: generating a plurality of additional fields in the wine database record, wherein the additional fields include additional wine-related information that is related to the wine stored in the bottle, and further wherein the additional wine-related information can be obtained from one or more of a plurality of sources including commercially available wine information databases.

According to the second aspect of the embodiments, the method further comprises: determining a storage location in the wine storage rack as the wine bottle is being stored; generating the alpha-numeric storage location, bottle location ID, based on the storage location, correlating the alpha-numeric storage location, bottle location ID, with the wine bottle identification, wine bottle ID; and updating the wine database record with the storage location, bottle location ID, for the specific bottle of wine as identified by the wine bottle ID, wherein the step of determining a storage location in the wine storage rack as the wine bottle is being stored comprises, receiving, via the at least one optical detector coupled to the at least one processor, a camera output signal representing an image of a wine bottle as it enters a specific wine bottle storage location, at a wine tracker application executing on the at least one processor; analyzing the camera output signal; and extracting the wine bottle ID from the camera output signal; extracting storage location information from the camera output signal; and assigning the extracted storage location from the camera output signal to the wine bottle ID, wherein the extracted storage location becomes the bottle location ID.

According to the second aspect of the embodiments, the at least one optical detector comprises at least one of a low-resolution still camera, a high-resolution still camera, a low-resolution video camera, a high-resolution video camera, an infra-red camera, a stereovision camera, and a coherent light transmitter and receiver.

According to a third aspect of the embodiments a wine storage area is provided, comprising: a wine storage area designed and built to store a plurality of wine bottles; a plurality of wine bottle storage locations within the wine storage area; at least one or more wine bottles stored in any of the wine bottle locations; at least one optical detector adapted to generate image information that includes image data of a first wine bottle as it is being stored into, or removed from, the wine bottle storage location, and wherein the at least one optical detector is further adapted to output the image information as a camera output signal; at least one processor communicatively coupled to the at least one optical detector; and a memory operatively connected with the at least one processor, wherein the memory stores computer-executable instructions that, when executed by the at least one processor, causes the at least one processor to execute a method that comprises: receiving, via the at least one optical detector, the camera output signal within a wine tracker application executing on the at least one processor; analyzing the camera output signal; and extracting wine information pertaining to the wine stored in the first wine bottle on the basis of the analysis of the camera output signal by the at least one processor and wine tracking application.

According to the third aspect of the embodiments, the method that is executed by the at least one processor further comprises: extracting wine information from the first wine bottle by processing a label on the first wine bottle; and performing one or both of optical character recognition processing on the label of the first wine bottle and image recognition processing on the label of the first wine bottle.

According to the third aspect of the embodiments, the method that is executed by the at least one processor further comprises: generating a respective wine database record for each bottle of wine that is tracked by the wine bottle tracking system; and storing the wine database record in the memory, wherein the wine database record comprises the wine information.

According to the third aspect of the embodiments, the wine database record includes a plurality of fields comprising at least a wine bottle identification field, a bottle location identification field, and a wine information identification field.

According to the third aspect of the embodiments, the wine bottle identification field comprises a unique alpha-numeric identification for each respective wine bottle analyzed by the wine bottle tracking system, and wherein the bottle location identification field comprises a unique alpha-numeric identification for each respective wine bottle that identifies its unique location within the wine storage area, and wherein the wine information identification field comprises a unique alpha-numeric identification for a respective type of wine that includes a unique set of wine information, and wherein the bottle location identification field includes storage location information that uniquely identifies a specific storage location of a respective bottle of wine within the wine storage area, and wherein the method that is executed by the at least one processor further comprises: generating a plurality of additional fields in the wine database record, wherein the additional fields include additional wine-related information that is related to the wine stored in the bottle, and further wherein the additional wine-related information can be obtained from one or more of a plurality of sources including commercially available wine information databases.

According to the third aspect of the embodiments, the at least one optical detector comprises at least one of a low-resolution still camera, a high-resolution still camera, a low-resolution video camera, a high-resolution video camera, an infra-red camera, a stereovision camera, and a coherent light transmitter and receiver.

According to a fourth aspects of the embodiments, a system for recognizing wine bottles stored in a wine storage area and for obtaining information about the stored wine bottles is provided, comprising: a plurality of wine bottle storage locations within a wine storage area; at least one or more wine bottles stored in any of the wine bottle locations; at least one optical detector adapted to generate image information that includes image data of a first wine bottle as it is being stored into, or removed from, the wine bottle storage location, and wherein the at least one optical detector is further adapted to output the image information as a camera output signal; at least one processor communicatively coupled to the at least one optical detector; and a memory operatively connected with the at least one processor, wherein the memory stores computer-executable instructions that, when executed by the at least one processor, causes the at least one processor to execute a method that comprises: receiving, via the at least one optical detector, the camera output signal within a wine tracker application executing on the processor; analyzing the camera output signal; extracting a first set of wine information pertaining to the wine stored in the first wine bottle on the basis of the analysis of the camera output signal by the processor and wine tracking application; capturing an image of a label of the first wine bottle in the camera output signal for the first wine bottle from the camera output signal; extracting a second set of wine information pertaining to wine stored in the first wine bottle from the captured image of the label of the first wine bottle; obtaining a third set of information electronically from one or more of a plurality of sources including commercially available wine information databases regarding the wine in the first wine bottle.

According to the fourth aspect of the embodiments, the method that is executed by the at least one processor further comprises: extracting additional wine information from the first wine bottle by processing a label on the first wine bottle.

According to the fourth aspect of the embodiments, the method that is executed by the at least one processor further comprises: performing optical character recognition processing on the label of the first wine bottle.

According to the fourth aspect of the embodiments, the method that is executed by the at least one processor further comprises: performing image recognition processing on the label of the first wine bottle.

According to the fourth aspect of the embodiments, the method that is executed by the at least one processor further comprises: generating a wine bottle identification (wine bottle ID) for each bottle of wine; generating a respective wine database record for each bottle of wine that is tracked by the wine bottle tracking system; storing the wine database record in the memory, wherein the wine database record comprises any one or more of the first set, second set, third set, and additional wine information; determining a storage location in the wine storage rack as the wine bottle is being stored; correlating each wine bottle ID of a respective wine bottle with the storage location of the respective wine bottle; and updating the wine database record for each new bottle of wine as it is stored into or removed from the wine bottle storage area.

According to the fourth aspect of the embodiments, the wine database record includes a plurality of fields comprising at least a wine bottle identification field, a bottle location identification field, and a wine information identification field.

According to the fourth aspect of the embodiments, the wine bottle identification field comprises a unique alpha-numeric identification for each respective wine bottle analyzed by the wine bottle tracking system, and wherein the bottle location identification field comprises a unique alpha-numeric identification for each respective wine bottle that identifies its unique location within the wine storage area, and wherein the wine information identification field comprises a unique alpha-numeric identification for a respective type of wine that includes a unique set of wine information.

According to the fourth aspect of the embodiments, the bottle location identification field includes storage location information that uniquely identifies a specific storage location of a respective bottle of wine within the wine storage area.

According to the fourth aspect of the embodiments, the method that is executed by the at least one processor further comprises: generating a plurality of additional fields in the wine database record, wherein the additional fields include further additional wine-related information that is related to the wine stored in the bottle.

According to the fourth aspect of the embodiments, the at least one optical detector comprises at least one of a low-resolution still camera, a high-resolution still camera, a low-resolution video camera, a high-resolution video camera, an infra-red camera, a stereovision camera, and a coherent light transmitter and receiver.

According to a fifth aspect of the embodiments, a method for recognizing wine bottles being stored in a wine storage area and for obtaining information about the stored wine bottles is provided, the method comprising: receiving, via at least one optical detector coupled to at least one processor, a camera output signal representing an image of a first wine bottle as it enters the wine bottle storage area, at a wine tracker application executing on the at least one processor, the wine tracker application stored in a memory associated with the at least one processor; analyzing the camera output signal; extracting a first set of wine information pertaining to the wine stored in the first wine bottle on the basis of the analysis of the camera output signal by the processor and wine tracking application; capturing an image of a label of the first wine bottle in the camera output signal for the first wine bottle from the camera output signal; extracting a second set of wine information pertaining to wine stored in the first wine bottle from the captured image of the label of the first wine bottle; and obtaining a third set of information electronically from one or more of a plurality of sources including commercially available wine information databases regarding the wine in the first wine bottle.

According to the fifth aspect of the embodiments, the method further comprises: extracting additional wine information from the first wine bottle by processing a label on the first wine bottle.

According to the fifth aspect of the embodiments, the method further comprises: performing optical character recognition processing on the label of the first wine bottle.

According to the fifth aspect of the embodiments, the method further comprises: performing image recognition processing on the label of the first wine bottle.

According to the fifth aspect of the embodiments, the method further comprises: generating a first wine bottle identification (first wine bottle ID) for the first wine bottle; assigning the first wine bottle ID to the first wine bottle; and generating a first wine database record in the memory associated with the processor for the first wine bottle.

According to the fifth aspect of the embodiments, the method further comprises: determining a storage location in the wine storage rack as the wine bottle is being stored; correlating the first wine bottle ID of the first wine bottle with the storage location of the first wine bottle; generating a first wine information identification (first wine info ID) for the first wine bottle; assigning the first wine info ID to the first wine bottle; and adding the first wine info ID to the first wine database record.

According to the fifth aspect of the embodiments, the method further comprises: generating a first wine bottle location identification (first bottle location ID) for the storage location of the first bottle of wine; and adding the first bottle location ID to the first wine database record for the first wine bottle.

According to the fifth aspect of the embodiments, the first wine database record includes a plurality of fields comprising at least a wine bottle identification field, a bottle location identification field, and a wine information identification field, and additional fields, and wherein the wine bottle ID comprises a unique alpha-numeric designator, and is stored in the wine bottle identification field, the bottle location ID comprises a comprises a unique alpha-numeric designator, and is stored in the bottle location identification field, the wine information ID comprises a comprises a unique alpha-numeric designator, and is stored in the wine information identification field, and wherein the additional fields include additional wine-related information that is related to the wine stored in the bottle.

According to the fifth aspect of the embodiments, the at least one optical detector comprises at least one of a low-resolution still camera, a high-resolution still camera, a low-resolution video camera, a high-resolution video camera, an infra-red camera, a stereovision camera, and a coherent light transmitter and receiver.

According to a sixth aspect of the embodiments, a method for recognizing wine bottles being removed from a wine storage area and for updating information about the stored wine bottles is provided, the method comprising: receiving, via at least one optical detector coupled to at least one processor, a camera output signal representing an image of the first wine bottle as it is removed from its respective bottle storage location in the wine bottle storage area, at a wine tracker application executing on at least one processor, the wine tracker application stored in a memory associated with the at least one processor; obtaining updated wine information from a plurality of sources to verify pricing and availability of the wine in the wine bottle; and updating a wine database record stored in the memory that the wine bottle has been removed from the bottle storage location and wine bottle storage area when the wine bottle is removed from the bottle storage area.

According to the sixth aspect of the embodiments, the method further comprises: verifying that the wine information obtained from the image of the label of the retrieved wine bottle matches the wine information stored in the wine database record as well as the wine bottle identification, bottle location identification, and the wine Info identification.

According to the sixth aspect of the embodiments, the step of verifying comprises: determining a bottle storage location and a bottle location identification associated with the bottle storage location; capturing an image of the label of the first wine bottle in the camera output signal for the first wine bottle; obtaining a wine bottle ID from a wine database record for the bottle location identification; obtaining the wine Info ID from the wine database record for the bottle location identification; and analyzing the image of the label and obtaining wine information from the image of the label, and wherein the first wine database record comprises a plurality of fields comprising at least a wine bottle identification field, a bottle location identification field, and a wine information identification field, and additional fields, and wherein the wine bottle ID comprises a unique alpha-numeric designator, and is stored in the wine bottle identification field, the bottle location ID comprises a comprises a unique alpha-numeric designator, and is stored in the bottle location identification field, the wine information ID comprises a comprises a unique alpha-numeric designator, and is stored in the wine information identification field, and wherein the additional fields include additional wine-related information that is related to the wine stored in the bottle.

According to the sixth aspect of the embodiments, the at least one optical detector comprises at least one of a low-resolution still camera, a high-resolution still camera, a low-resolution video camera, a high-resolution video camera, an infra-red camera, a stereovision camera, and a coherent light transmitter and receiver.

According to a seventh aspect of the embodiments, a system for determining active inventory valuations of wine stored in a wine storage area is provided, comprising: a plurality of wine bottle storage locations within a wine storage area; at least one or more wine bottles stored in any of the wine bottle locations; at least one optical detector adapted to generate image information that includes image data of each of the at least one or more wine bottles as they are being stored into, or removed from, the wine bottle storage location, and wherein the at least one optical detector is further adapted to output the image information as a camera output signal; at least one processor communicatively coupled to the at least one optical detector; and a memory operatively connected with the at least one processor, wherein the memory stores computer-executable instructions embodied as a wine tracker application that, when executed by the at least one processor, causes the at least one processor to execute a method that comprises: extracting wine information pertaining to the wine stored in each of the at least one or more wine bottles as each is being stored into, or removed from, the wine storage area; tracking such extractions on a per consumer basis, and storing the same as wine consumer purchase-use tracking information; and determining an active inventory valuation based on an accumulation and processing all of the wine consumer purchase-use tracking information for all consumers.

According to the seventh aspect of the embodiments, the step of extracting wine information by the method that is executed by the at least one processor further comprises: receiving, via the at least one optical detector, the camera output signal within a wine tracker application executing on the at least one processor; analyzing the camera output signal; and extracting wine information pertaining to the wine stored in the first wine bottle on the basis of the analysis of the camera output signal by the at least one processor and wine tracking application.

According to the seventh aspect of the embodiments, the method that is executed by the at least one processor further comprises: extracting wine information from the first wine bottle by processing a label on the first wine bottle, and wherein the step of processing a label comprises one of performing optical character recognition processing on the label of the first wine bottle, and performing image recognition processing on the label of the first wine bottle.

According to the seventh aspect of the embodiments, the method that is executed by the at least one processor further comprises: generating a respective wine database record for each bottle of wine that is tracked by the wine bottle tracking system; and storing the wine database record in the memory, wherein the wine database record comprises the wine information.

According to the seventh aspect of the embodiments, the wine database record includes a plurality of fields comprising at least a wine bottle identification field, a bottle location identification field, and a wine information identification field, and wherein the wine bottle identification field comprises a unique alpha-numeric identification for each respective wine bottle analyzed by the wine bottle tracking system, and wherein the bottle location identification field comprises a unique alpha-numeric identification for each respective wine bottle that identifies its unique location within the wine storage area, and wherein the wine information identification field comprises a unique alpha-numeric identification for a respective type of wine that includes a unique set of wine information, and further wherein the bottle location identification field includes storage location information that uniquely identifies a specific storage location of a respective bottle of wine within the wine storage area.

According to the seventh aspect of the embodiments, the method that is executed by the at least one processor further comprises: generating a plurality of additional fields in the wine database record, wherein the additional fields include additional wine-related information that is related to the wine stored in the bottle, and further wherein the additional wine-related information can be obtained from one or more of a plurality of sources including commercially available wine information databases, and includes one or more for each bottle of wine stored in the storage area of current prices, estimated future prices, current availability, estimated future availability, and news information pertaining to the wine, vineyard, shipper, and any other entity related to the wine stored in the wine bottle.

According to the seventh aspect of the embodiments, the step of determining an active inventory valuation by the method that is executed by the at least one processor comprises: determining a current total value of wines stored in the wine storage area on a basis of each consumer that may have stored wine in the wine storage area and on a basis of an owner of the wine storage area, wherein such current total value is based on one or more of the information stored in the wine database.

According to the seventh aspect of the embodiments, the step of determining an active inventory valuation by the method that is executed by the at least one processor comprises: determining a predicted total value of wines stored in the wine storage area on a basis of each consumer that may have stored wine in the wine storage area and on a basis of an owner of the wine storage area, wherein such current total value is based on one or more of the information stored in the wine database.

According to the seventh aspect of the embodiments, the at least one optical detector comprises at least one of a low-resolution still camera, a high-resolution still camera, a low-resolution video camera, a high-resolution video camera, an infra-red camera, a stereovision camera, and a coherent light transmitter and receiver.

According to an eighth aspect of the embodiments a system for predicting consumer behavior regarding wine consumption is provided, comprising: a plurality of wine bottle storage locations within a wine storage area; at least one or more wine bottles stored in any of the wine bottle locations; at least one optical detector adapted to generate image information that includes image data of each of the at least one or more wine bottles as they are being stored into, or removed from, the wine bottle storage location, and wherein the at least one optical detector is further adapted to output the image information as a camera output signal; at least one processor communicatively coupled to the at least one optical detector; and a memory operatively connected with the at least one processor, wherein the memory stores computer-executable instructions embodied as a wine tracker application that, when executed by the at least one processor, causes the at least one processor to execute a method that comprises: extracting wine information pertaining to the wine stored in each of the at least one or more wine bottles as each is being stored into, or removed from, the wine storage area; tracking such extractions on a per consumer basis, and storing the same as wine consumer purchase-use tracking information; and providing a list of at least one wine to purchase or taste based on an accumulation and processing all of the wine consumer purchase-use tracking information for all consumers.

According to the eighth aspect of the embodiments, the step of extracting wine information by the method that is executed by the at least one processor further comprises: receiving, via the at least one optical detector, the camera output signal within a wine tracker application executing on the at least one processor; analyzing the camera output signal; and extracting wine information pertaining to the wine stored in the first wine bottle on the basis of the analysis of the camera output signal by the at least one processor and wine tracking application.

According to the eighth aspect of the embodiments, the method that is executed by the at least one processor further comprises: extracting wine information from the first wine bottle by processing a label on the first wine bottle, and wherein the step of processing a label comprises one of performing optical character recognition processing on the label of the first wine bottle, and performing image recognition processing on the label of the first wine bottle.

According to the eighth aspect of the embodiments, the method that is executed by the at least one processor further comprises: generating a respective wine database record for each bottle of wine that is tracked by the wine bottle tracking system; and storing the wine database record in the memory, wherein the wine database record comprises the wine information.

According to the eighth aspect of the embodiments, the wine database record includes a plurality of fields comprising at least a wine bottle identification field, a bottle location identification field, and a wine information identification field, and wherein the wine bottle identification field comprises a unique alpha-numeric identification for each respective wine bottle analyzed by the wine bottle tracking system, and wherein the bottle location identification field comprises a unique alpha-numeric identification for each respective wine bottle that identifies its unique location within the wine storage area, and wherein the wine information identification field comprises a unique alpha-numeric identification for a respective type of wine that includes a unique set of wine information, and further wherein the bottle location identification field includes storage location information that uniquely identifies a specific storage location of a respective bottle of wine within the wine storage area.

According to the eighth aspect of the embodiments, the method that is executed by the at least one processor further comprises: generating a plurality of additional fields in the wine database record, wherein the additional fields include additional wine-related information that is related to the wine stored in the bottle, and further wherein the additional wine-related information can be obtained from one or more of a plurality of sources including commercially available wine information databases, and includes one or more for each bottle of wine stored in the storage area of current prices, estimated future prices, current availability, estimated future availability, and news information pertaining to the wine, vineyard, shipper, and any other entity related to the wine stored in the wine bottle.

According to the eighth aspect of the embodiments, the step of providing a list of at least one wine to purchase or taste by the method that is executed by the at least one processor comprises: determining each type or category of wine previously consumed or purchased by a consumer affiliated with the wine storage area; obtaining prices of new untasted wines that are substantially similar in taste characteristics to one or more of the wines previously purchased by the consumer; generating one or more groups of wines that are substantially similar in taste characteristics to the one or more of the wines previously consumed or purchased by the consumer, wherein each group is within a preselected price range; and providing the one or more groups of wines to the consumer such that the consumer is provided with wines that match the taste characteristics of the wines previously consumed or purchased, but are grouped according to cost within a preselected price range.

According to the eighth aspect of the embodiments, the method that is executed by the at least one processor further comprises: providing additional wine-related information obtained through one or more commercial wine databases for each of the groups of wine provided to the consumer; and providing recommended food wine pairings for each of the one or more groups of wine provided to the consumer.

According to the eighth aspect of the embodiments, the at least one optical detector comprises at least one of a low-resolution still camera, a high-resolution still camera, a low-resolution video camera, a high-resolution video camera, an infra-red camera, a stereovision camera, and a coherent light transmitter and receiver.

According to a ninth aspect of the embodiments a method for determining an active inventory valuation of wines stored in a wine storage area is provided, the method comprising: receiving, via at least one optical detector coupled to at least one processor, a camera output signal representing an image of a wine bottle as it enters the wine bottle storage area, at a wine tracker application executing on the at least one processor, the wine tracker application stored in a memory associated with the at least one processor; analyzing the camera output signal; extracting wine information pertaining to the wine stored in each of the at least one or more wine bottles as each is being stored into, or removed from, the wine storage area; tracking such extractions on a per consumer basis, and storing the same as wine consumer purchase-use tracking information; and determining an active inventory valuation based on an accumulation and processing all of the wine consumer purchase-use tracking information for all consumers.

According to the ninth aspect of the embodiments, the method further comprises: generating a respective wine database record for each bottle of wine that is tracked by the wine bottle tracking system; storing the wine database record in the memory, wherein the wine database record comprises the wine information, and includes a plurality of fields comprising at least a wine bottle identification field, a bottle location identification field, and a wine information identification field, and wherein the wine bottle identification field comprises a unique alpha-numeric identification for each respective wine bottle analyzed by the wine bottle tracking system, and wherein the bottle location identification field comprises a unique alpha-numeric identification for each respective wine bottle that identifies its unique location within the wine storage area, and wherein the wine information identification field comprises a unique alpha-numeric identification for a respective type of wine that includes a unique set of wine information, and further wherein the bottle location identification field includes storage location information that uniquely identifies a specific storage location of a respective bottle of wine within the wine storage area; and generating a plurality of additional fields in the wine database record, wherein the additional fields include additional wine-related information that is related to the wine stored in the bottle, and further wherein the additional wine-related information can be obtained from one or more of a plurality of sources including commercially available wine information databases, and includes one or more for each bottle of wine stored in the storage area of current prices, estimated future prices, current availability, estimated future availability, and news information pertaining to the wine, vineyard, shipper, and any other entity related to the wine stored in the wine bottle.

According to the ninth aspect of the embodiments, the method further comprises: determining a current total value of wines stored in the wine storage area on a basis of each consumer that may have stored wine in the wine storage area and on a basis of an owner of the wine storage area, wherein such current total value is based on one or more of the information stored in the wine database; and determining a predicted total value of wines stored in the wine storage area on a basis of each consumer that may have stored wine in the wine storage area and on a basis of an owner of the wine storage area, wherein such current total value is based on one or more of the information stored in the wine database.

According to the ninth aspect of the embodiments, the method further comprises: collecting, retaining, and disseminating any information used by the method in accordance with one or more laws related to privacy and security of data in the jurisdiction that the method is used.

According to the ninth aspect of the embodiments, the at least one optical detector comprises at least one of a low-resolution still camera, a high-resolution still camera, a low-resolution video camera, a high-resolution video camera, an infra-red camera, a stereovision camera, and a coherent light transmitter and receiver.

### BRIEF DESCRIPTION OF THE DRAWINGS

The above and other objects and features of the embodiments will become apparent and more readily appreciated from the following description of the embodiments with reference to the following figures. Different aspects of the embodiments are illustrated in reference figures of the drawings. It is intended that the embodiments and figures disclosed herein are to be considered to be illustrative rather than limiting. The components in the drawings are not necessarily drawn to scale, emphasis instead being placed upon clearly illustrating the principles of the aspects of the embodiments. In the drawings, like reference numerals designate corresponding parts throughout the several views.

FIG. 1 illustrates a conceptual block diagram of a computing network environment for managing, tracking, and identifying bottles of wine as they are stored in a wine bottle storage area and retrieved from the wine bottle storage area, and for providing information relevant to the bottles of wine, according to aspects of the embodiments.

FIG. 2 illustrates a detailed block diagram of a wine bottle tracking system operating within the network of FIG. 1 according to aspects of the embodiments.

FIG. 3 illustrates a flow diagram of a method for capturing information about a wine bottle as it is stored in the wine bottle storage area, and storing the same, along with other relevant related wine information according to aspects of the embodiments.

FIG. 4 illustrates a flow diagram of a method for capturing information about a wine bottle as it is retrieved from the wine bottle storage area and updating a wine bottle storage information database according to aspects of the embodiments.

FIG. 5 illustrates a detailed block diagram of a wine bottle tracking system utilizing a coherent light transmitter and detector and operating within the network of FIG. 1 according to aspects of the embodiments.

FIG. 6 illustrates a flow diagram of a method for using the wine bottle tracking system of FIG. 5 to determine a status of a particular wine bottle storage and location according to aspects of the embodiments.

FIG. 7 illustrates a simplified diagram of a database storage element that contains a plurality of fields for storing relevant wine information for use with the systems and methods of FIGS. 1-6 according to aspects of the embodiments.

FIG. 8 illustrates a block diagram of the major components of a computer device, personal computer, server, laptop, and/or personal electronic device (herein after, “computer device”) suitable for use to implement the methods shown in regard to FIGS. 3, 4, and 6, among others, for tracking wine bottles in a wine bottle storage area on a computer device using the wine bottle tracking software applications according to aspects of the embodiments.

FIG. 9 illustrates a block diagram of the network system of FIG. 2 within which the system and method for tracking wine bottles on a computer device can be implemented using the wine bottle tracking software application according to aspects of the embodiments.

### DETAILED DESCRIPTION

The embodiments are described more fully hereinafter with reference to the accompanying drawings, in which embodiments of the inventive concept are shown. In the drawings, the size and relative sizes of layers and regions may be exaggerated for clarity. Like numbers refer to like elements throughout. The embodiments may, however, be embodied in many different forms and should not be construed as limited to the embodiments set forth herein. Rather, these embodiments are provided so that this disclosure will be thorough and complete, and will fully convey the scope of the inventive concept to those skilled in the art. The scope of the embodiments is therefore defined by the appended claims.

Reference throughout the specification to “one embodiment” or “an embodiment” means that a particular feature, structure, or characteristic described in connection with an embodiment is included in at least one embodiment of the embodiments. Thus, the appearance of the phrases “in one embodiment” or “in an embodiment” in various places throughout the specification is not necessarily referring to the same embodiment. Further, the particular feature, structures, or characteristics may be combined in any suitable manner in one or more embodiments.

### List of Reference Numbers for the Elements in the Drawings in Numerical Order

The following is a list of the major elements in the drawings in numerical order.
100 Wine Bottle Tracking System (Tracking System 100)
102 Wine Bottle Tracker Application (Tracker App)
104 Wine Information Storage Database Record (Wine DB Record)
106 Internet/Network (Network)
108 Wine Information and Tracker Management Server (Wine Inf. Server)
110 Wine Information and Tracker Database Server (Wine DB Server)
112 Wine Information and Tracker Application (Wine Inf. App)
114 Wine Bottle Tracker and Management Server/Personal Computer (PC) (Tracker and Management Server)
116 Mobile Device
118 Available Wine Information Database(s) (Wine Information Database)
102′ Modified Tracker App
202 Optical Detector/Camera (Camera)
204 Internal Bus
206 Controller/Processor
208 Memory
210 Network
212 Reflected Light
214 Wine Storage Area
216 Wine Storage Bin (Bin)
218 Wine Bottle
220 Camera Output Signal
222 Camera Control/Command Signal
224 Motion Detector
226 Thermometer
228 Scale
230 Hygrometer
232 Accelerometer
234 Biometric Sensor(s)
236 Physical Security Device(s)
238 Wired/Wireless Interface
300 Method for Creating Wine Storage Information Database
302-314 Method Steps for Method 300
400 Method for Updating Wine Storage Information Database
402-410 Method Steps for Method 400
500 Wine Bottle Tracking System with Coherent Light Transmitter and Receiver (Tracking System 500)
502 Coherent Light Transmitter (Transmitter)
504 Coherent Light Detector (Detector)
506 Transmitted Coherent Light
508 Reflected Coherent Light
600 Method for Determining Status of Wine Storage Location
602-610 Method Steps for Method 600
702a-q Wine Information Storage Database Record Fields
801 Shell/Box
802 Integrated Display
804 Internal Data/Command Bus (Bus)
806 Processor Internal Memory
808 Processor(s)
810 Universal Serial Bus (USB) Port
811 Ethernet Port
812 Compact Disk (CD)/Digital Versatile Disk (DVD) Read/Write (RW) (CD/DVD/RW) Drive
814 Floppy Diskette Drive
816 Hard Disk Drive (HDD)
818 Read-Only Memory (ROM)
820 Random Access Memory (RAM)
822 Video Graphics Array (VGA) Port or High Definition Multimedia Interface (HDMI)
824 External Memory Storage Device
826 External Display
828 Keyboard
830 Mouse
832 Processor Board/PC Internal Memory (Internal Memory)
834 Flash Drive Memory
836 CD/DVD Diskettes
838 Floppy Diskettes
842 Wi-Fi Transceiver
844 BlueTooth (BT) Transceiver
846 Near Field Communications (NFC) Transceiver
848 Third Generation (3G), Fourth Generation (4G), Long Term Evolution (LTE), Fifth Generation (5G) Cellular Transceiver (Cellular Transceiver)
850 Communications Satellite/Global Positioning System (Satellite) Transceiver
852 Antenna
856 Universal Serial Bus (USB) Cable
858 Ethernet Cable (CATS Cable)
860 Printer/Scanner/Facsimile Machine (Printer/Scanner/Fax)
862 VGA/HDMI Cable
902 Mobile Device
906 Internet Service Provider (ISP)
908 Modulator/Demodulator (Modem)
910 Wireless Router
912. Plain Old Telephone Service (POTS) Provider
914 Cellular Service Provider
918 Communication Satellites
920 Cellular Telecommunications Service Tower (Cellular Tower)
924 GPS Station
926 Satellite Communication Systems Control Station
928 Global Positioning System (GPS) Satellite

### List of Acronyms Used in the Specification in Alphabetical Order

The following is a list of the acronyms used in the specification in alphabetical order.
3G Third Generation
4G Fourth Generation
5G Fifth Generation
API Application Programming Interface
App Executable Software Programming Code/Application
AR Augmented Reality
ASIC Application Specific Integrated Circuit
BIOS Basic Input/Output System
BT Bluetooth
CD Compact Disk
CRT Cathode Ray Tube
DVD Digital Video Disk
EEPROM Electrically Erasable Programmable Read Only Memory
FPGA Field Programmable Gate Array
GAN Global Area Network
GPS Global Positioning System
GUI Graphical User Interface
HDD Hard Disk Drive
HDMI High Definition Multimedia Interface
IoT Internet of Things
ISP Internet Service Provider
LCD Liquid Crystal Display
LED Light Emitting Diode Display
LTE Long Term Evolution
MODEM Modulator-Demodulator
NFC Near Field Communications
OCR Optical Character Recognition
PC Personal Computer
PDA Personal Digital Assistant
PED Personal Electronic Device
POTS Plain Old Telephone Service
PROM Programmable Read Only Memory
RAM Random Access Memory
ROM Read Only Memory
RW Read/Write
UI User Interface
USB Universal Serial Bus
UV Ultraviolet Light
UVPROM Ultraviolet Light Erasable Programmable Read Only Memory
VGA Video Graphics Array

The different aspects of the embodiments described herein pertain to the context of systems, methods, and modes for a computer- and network-based wine bottle inventory and storage management system, but is not limited thereto, except as may be set forth expressly in the appended claims.

As briefly described above, aspects of the embodiments are directed to management of a wine bottle storage area or facility. A wine bottle storage area can include one or more of a wine cellar, whether privately or commercially owned, retail shelving or racks, warehouses, vineyard storage facilities, and the like. In fulfillment of the dual purposes of clarity and brevity, from hereon in, reference will be made only to a “wine bottle storage area” but the same shall not be taken in a limiting manner Within the wine bottle storage area, there can be individual bins, but that is not necessarily always the case. In many retail enterprise locations, many of the same type of wine bottles are stored together in a bin, comprising a racks or shelving. Regardless of the form and manner of storage, aspects of the embodiments provide for the inventory management and control of the bottles of wine, as described below, and shown in the accompanying Figure.

Aspects of such management include recording when a new wine bottle is added to a wine bottle storage area, when it is retrieved, obtaining information from the wine bottle, and obtaining information from related sources regarding the particular wine in the wine bottle, and storing such assembled and collected data together in one or more wine bottle information databases that can be locally and/or remotely located. In addition, aspects of the embodiments include a system and method that can find where a particular or desired bottle of wine might be locate without knowing beforehand where it is stored, that is, being able to search for one or more bottles of wine based on any one or more of the assembled and collected information that comprises the wine bottle information database. The above description of the aspects of the embodiments is not meant to be, and should not be taken as limiting, as the aspects of the embodiments are more fully described below, in conjunction with the accompanying Figures and the claims.

Uses of the aspects of the embodiments can include one or more of an artificial intelligence-based system that is capable of automating the inventory management of objects/items resting in a stored location by employing computer vision techniques. For example, aspects of the embodiments can be used to monitor/track wine bottles stored in a wine cellar, clothing items in a closet, virtually any type of merchandise located on shelves of a store, or objects located in an inventory, such as spare parts stored in a warehouse, among other uses. According to further aspects of the embodiments, the systems and methods described herein describe an intelligent and automated system for inventory management (identifying and tracking) of wine bottles stored in a wine bottle storage area.

Aspects of the embodiments substantially solve the problem described above in regard to inventory management of wine bottles in one or more of a wine cellar, retail store, wholesale warehouse, distributers, or in vineyards, among other locations that large quantities of wine are stored for use or sale (wine bottle storage area). Such problems are substantially solved by a system and method for substantially completely automating the above described requirements for a wine bottle inventory management system.

According to aspects of the embodiments, cameras and computer vision detection and tracking algorithms can be employed to substantially automatically detect and track the placement of a new wine bottle into a wine bottle storage area and store the location information associated with the bottle in the automated system. According to aspects of the embodiments, the systems and methods described herein can detect a new wine bottle, and capture the information printed on a label of the wine bottle. There are at least two methods for capturing the information contained on the wine bottle label. A first method according to aspects of the embodiments is to perform optical character recognition (OCR) on the wine bottle label, the use of which is known to those of skill in the art. The captured information in this first case can be in the form of text and stored. A second method is to perform one or more image processing algorithms on the image of the wine bottle label and find matching images in a database of such wine bottle label images. The matched wine bottle label can then have associated with it information pertaining to the wine in the wine bottle. In either case, information pertaining to the wine bottle can be obtained from the wine bottle label.

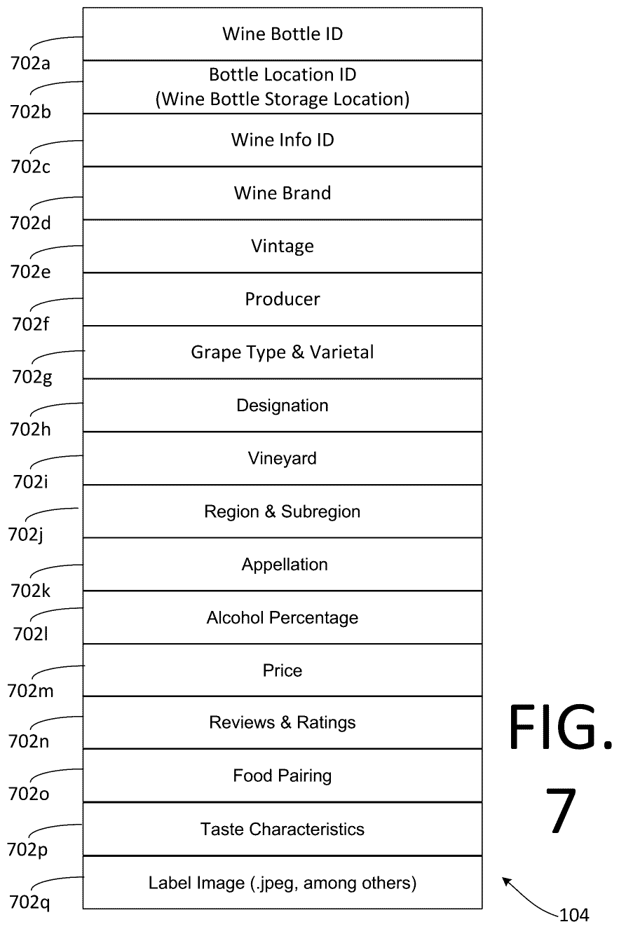

According to aspects of the embodiments, wine bottle information, regardless of form (e.g., text, images, among other types) that is obtained using the system and methods of the aspects of the embodiments described herein can be referred to as captured wine information and stored as a database storage element, which can be referred to as wine information storage database record (wine DB record) 104. Wine DB record 104 can include information about the particular wine in the wine bottle and other related information, and which is represented as the elements shown in FIG. 7. In addition, wine DB record 104 can include captured wine bottle label images (e.g., 702q, and stored as a “.jpeg” file, among other types), among other images (such as a photo of the particular storage location of the wine bottle, among other images). According to still further aspects of the embodiments, wine DB record can include additional wine information obtained from one or more available wine information databases (wine information database) 118. Wine information database 118 can be a commercially available product or service, or it can be generated privately; wine information database 118 can be obtained or accessed through network 106, and copies of one or more of wine information databases 118 can be stored on any one or more of devices 108, 110, 100, 116, 114, and 500. Thus, wine DB record 104 comprises captured information by systems 100, 500, and other relevant/related wine information from wine information databases 118 according to aspects of the embodiments. According to still further aspects of the embodiments, users or implementors of the systems and methods described herein can accumulate their own information, from private and/or commercial sources, and create their own wine information databases 118 that can then be joined with Wine Bottle ID 702a, Bottle Location ID 702b, and Wine Info ID 702c to create wine DB record 104 comprised on their one accumulated/researched wine information, and/or obtained wine information. By way of non-limiting example, such additional or accumulated or researched wine information can include valuation of certain wines; as those of skill in the art can appreciate, some purchasers of wine do so as an investment; that is, their wine cellars, which can number in the hundreds, if not thousands of bottles, are actually investments that can gain or lose value over time. Such wine bottle valuations can then be used by consumers to make purchase decisions solely based on the likelihood of the “return-on-investment” (ROI) valuations that can be included in the created wine DB records 104; this can be recognized as an “added value” to the systems and methods of the aspects of the embodiments in addition to the inventory management control functions and features described herein.

The elements or components of Wine DB record 104 and wine information database 118 are described in greater detail below. Wine DB record 104 can be stored on one or more of local and remote devices in fulfilment of the dual purposes of security and accessibility. One or more of the elements of wine DB record 104 can be obtained from external sources (external sources, in this case, indicates wine information that has not been primarily obtained by the systems and methods described herein according to the aspects of the embodiments). One or more of the elements of wine DB record 104 can be found using previously captured information such as the text information obtained using OCR techniques, or by one or more images of the wine bottle label and/or wine bottle. That is, if a wine bottle label is successfully captured one or more external wine information databases 118 can be searched on the basis of one or more images alone, text alone, or any combination thereof. Such external sources of wine information can be retrieved using an existing stored database in the automated system, an external wine information database, and/or wine information can be obtained from both sources. External wine information databases 118 can be obtained by accessing an application programming interface (API). For the purposes of this discussion, such externally obtained wine information can be referred to as wine information databases 118.

Upon capturing the label information, which can be performed using optical character recognition (OCR) techniques or image processing techniques, the automated system and method can extract wine information associated with the wine bottle label, such as brand/winery, grape type and varietal, and vintage, and then associate that information with the wine bottle before storing them in the system. According to further aspects of the embodiments, a unique bottle identifier (bottle ID) can be generated and assigned to the wine bottle as it is being stored, along with the storage location information. The previously gathered wine information (described in part above, and in greater detail below), along with the assigned bottle ID and storage location information can be stored as a database storage element, referred to as wine information storage database record (wine DB record) 104 below, a block diagram of which is shown in FIG. 7. Wine DB record 104 can be stored on one or more of local and remote devices in fulfilment of the dual purposes of security and accessibility.

According to further aspects of the embodiments, each wine bottle can be tracked using a camera until it is placed/stored in a location in the wine bottle storage area. The storage location of the wine bottle in the wine bottle storage area can be identified by an identifier (location ID), wherein the location ID is associated with the bottle ID and stored in the automated system. According to further aspects of the embodiments, the systems and methods described herein can track the wine bottle as it is removed from a storage location and update the database accordingly. According to further aspects of the embodiments, it is sometimes the case that wine bottles are moved from one location to another within a wine bottle storage area, and the systems and methods described herein can keep track of the movement and re-storing of a bottle that is not technically new to the wine bottle storage area, but that has acquired a new storage location.

According to further aspects of the embodiments, wine information can be retrieved using an existing stored database in the automated system, wine information can be retrieved using an external wine information database 118, and/or wine information can be obtained from both sources. External wine information databases 118 can be obtained by accessing an application programming interface (API).

According to further aspects of the embodiments, wine information can be searched by manually entering wine information fields or can be searched through an automated process. In regard to the automated process, the wine label (or barcode or other forms of unique identifier for the wine bottle) is scanned, and the system can extract the wine information from the label and/or the barcode. The wine information comprises at least one of: wine brand; vintage; producer; grape type and varietal; designation; vineyard; region and sub-region; appellation; alcohol percentage; price; reviews and ratings; food pairing; and taste characteristics. According to further aspects of the embodiments, computer vision techniques can be employed to automate obtaining wine information by scanning the bottle's label using an image scanner/camera. An intelligent scanner can extract whatever wine information that is located on the label image employing methods using OCR and image processing techniques. The system can maintain or access one or more wine information databases 118 that can comprise all or substantially all of the above described wine information, and can extract the wine information related to the scanned wine bottle by finding a visual match for the scanned label from a label database and/or printed information that is located on the label of the wine bottle.

According to aspects of the embodiments, the wine bottle ID associated with the wine bottle can be a photo of the label, some or all of the information encoded in an NFC tag, some, or all of the information in an RFID tag, and/or some or all of the information that is encoded in a barcode. Thus, according to aspects of the embodiments, the wine bottle ID can include one or more of a numeric characters, alpha characters, alpha-numeric characters, and/or images.

According to further aspects of the embodiments, a camera can be used to track the movement of a wine bottle that is introduced to the wine bottle storage area until it is stored. That is, the systems and methods as described herein according to aspects of the embodiments can capture an image of the label of the wine bottle, and then track its movement.

One such method for tracking and capturing wine bottle label information can include use of one or more low-resolution and/or no-zoom cameras to track the wine bottle movement and its position within the wine bottle storage area. The tracking can begin as soon as image recognition applications detect an image of a wine bottle, and then can look for a label on the wine bottle and continue such tracking until no occlusion of the wine bottle label occurs. According to further aspects of the embodiments, when the wine bottle label is substantially fully visible, one or more high-resolution and/or zoom cameras can capture a detailed image of the wine bottle label. According to further aspects of the embodiments, high resolution cameras can be used to not only capture detailed images of the label of the wine bottle, but also to perform the tracking function.

As those of skill in the art can appreciate, low-resolution and no-zoom cameras are less expensive and less complex than high-resolution and zoom cameras. Processing the video feeds from these cameras also requires less processing power. Therefore, they can be used in circumstances when hardware cost and complexity are of concern. In some other embodiments, the first and second steps both use high-resolution and/or zoom Cameras.

According to further aspects of the embodiments, capturing an image of the wine bottle label further comprises applying a transformation to the captured image to remove bottle curvature, and then flattening the label image. Furthermore, capturing an image of the wine bottle label can include extracting key features of the images. As those of skill in the art can appreciate, there are several image processing algorithms currently available that can be used with the systems and methods described herein to extract key features, such as SIFT (Scale-Invariant Feature Transform), SURF (Speeded-Up Robust Features), BRIEF (Binary Robust Independent Elementary Features), and ORD (Oriented Fast and Rotated BRIEF). In each of the aforementioned image processing algorithms, the “features” referred to are those portions of the image that are not sensitive to scale, rotation, and transformation. Deep Learning (DL) can also be used to train Convolutional Neural Network (CNN) models to extract these key “features” of the label scan that uniquely identify each label. According to further aspect of the embodiments, capturing an image of the wine bottle label further comprises comparing the extracted image's key features with a bank of stored features in the automated tracking system database and finding the closest match. According to further aspects of the embodiments, capturing an image of the wine bottle label comprises extracting text from the label using OCR, which can then be used to increase the accuracy of entering the wine bottle information into the automated tracking system database.

According to further aspects of the embodiments, another system and method described herein can be used to track placement of a wine bottle in a location in the wine bottle storage area using one or more cameras. The one or more cameras can be used for tracking the placement of the bottle can be the same or different as the cameras used for capturing the wine bottle label. The tracking and capturing of the placement of the wine bottle in a location in the wine bottle storage area can include one or more of the following steps: tracking the wine bottle movement and its position using either or both of a low resolution or high resolution/zoom camera; stopping the tracking when the wine bottle is placed/stored in a location (the bottle becomes stationary); identifying the location where the wine bottle has been stored and generating a Bottle Location ID that can be associated with the wine bottle; and comparing views of the wine bottle and storage location before and after placement in the storage location to verify that the identified storage location is correct.

According to further aspects of the embodiments, a Bottle Location Identifier (Bottle Location ID) can be associated with a particular wine bottle. The location ID can include the coordinates associated with the location of the wine bottle in the wine bottle storage area. Further, the location ID can include coordinates associated with the location of the wine bottle in the image/picture of the wine bottle storage area, wherein the coordinates can include (x, y) pixel coordinates in numerical form of the corners of the bounding box for the location of a wine bottle in the image/picture of the wine bottle storage area. According to aspects of the embodiments, the image/picture of the wine bottle storage area can include a camera view of the wine bottle storage area, and the images of the wine bottle storage area can include one or more camera views, from different angles and/or locations.

According to aspects of the embodiments, the comparison between the views/images of the wine bottle storage area before and after wine placement can be performed by comparing the image of the wine bottle storage area before the wine bottle was stored, and the image of the wine bottle storage area after the wine bottle was stored. The comparison can be performed by creating a difference between the before and after images, and the difference image can indicate the location of the stored wine bottle.

As those of skill in the art can appreciate, determining differences between images on a pixel by pixel basis can result in an inordinately large amount of “false positives,” meaning that if a difference is detected because of a slight camera movement, or change in lighting, or some other similar micro-change causing event, a change will be flagged, when in actuality none has occurred. To mitigate such false positives, aspects of the embodiments, utilize certain techniques to substantially eliminate or diminish such false positives. These techniques can include one or more of applying some background and foreground segmentation techniques to identify areas that might have changed between the two images, comparing the content and the texture of the images for these suspected areas, applying a wine bottle image detector and/or classifier to these areas to confirm addition or removal of a wine bottle is causing the change, and extracting some image features for these suspected areas and measuring the distance between the image features to confirm the change in content. According to further aspects of the embodiments, one or more of a stereovision camera, a depth sensing camera or a Light Detection and Ranging (LIDAR) device can be utilized to detect changes in the depth of certain areas in the before and after images to verify a wine bottle has been added or removed from the wine bottle storage area.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer and/or specifically designed and fabricated electronic devices, those skilled in the art will recognize that aspects may also be implemented in combination with other program modules.

Generally, program modules include routines, programs, components, data structures, and other types of structures that perform particular tasks or implement particular abstract data types. Moreover, those of skill in the art can appreciate that different aspects of the embodiments can be practiced with other computer system configurations, including hand-held devices, multiprocessor systems, microprocessor-based or programmable consumer electronics, minicomputers, mainframe computers, and comparable computing devices. Aspects of the embodiments can also be practiced in distributed computing environments where tasks are performed by remote processing devices that are linked through a communications network. In a distributed computing environment, program modules can be located in both local and remote memory storage devices.

Aspects of the embodiments can be implemented as a computer-implemented process (method), a computing system, or as an article of manufacture, such as a computer program product or computer readable media. The computer program product can be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media. Other hardware components can include one or more of a low-resolution camera, one or more of a high-resolution camera, one or more LASER transceivers, or any combination of low-resolution cameras and high-resolution cameras and LASER transceivers.

Throughout this specification, the term “platform” can be a combination of software and hardware components for providing share permissions and organization of content in an application with multiple levels of organizational hierarchy. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and one or more processors that includes a server, a desktop computer, a laptop computer, a tablet computer, a smart phone, a vehicle mount computer, or a wearable computer. A memory can be a removable or non-removable component of a computing device configured to store one or more instructions to be executed by one or more processors. A processor can be a component of a computing device coupled to a memory and configured to execute programs in conjunction with instructions stored by the memory. Actions or operations described herein may be executed on a single processor, on multiple processors (in a single machine or distributed over multiple machines), or on one or more cores of a multi-core processor. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience can be embodied as a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) can be a set of routines, protocols, and tools for an application or service that allow the application or service to interact or communicate with one or more other applications and services managed by separate entities.

Aspects of the embodiments address a need that arises from a lack of sophistication in currently available wine bottle inventory management systems, and the various aspects of the embodiments described herein make use of very large scale of operations created by networked computing and cloud-based services that cannot be managed by humans. The actions/operations described herein are not a mere use of a computer, but address results of a system that is a direct consequence of software used as a service such as communication services offered in conjunction with communications.

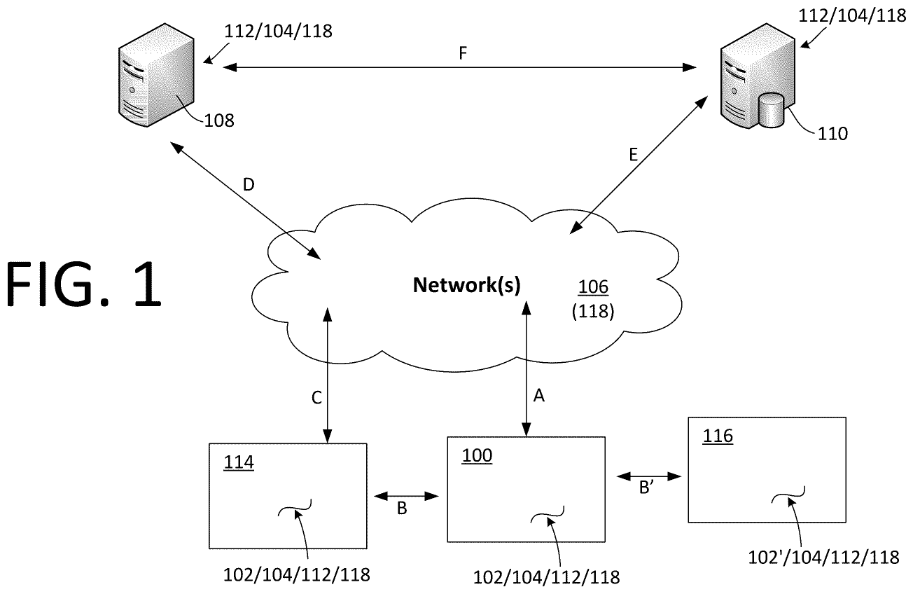

FIGS. 1-9 illustrate various aspects of a computer and network-based wine bottle inventory and storage management system, including, according to certain aspects of the embodiments, use of the internet or other similar networks. The wine bottle inventory and storage management programs provides a practical, technical solution to the problem of managing the inventory control of wine bottles in a wine bottle storage area; as those of skill in the art can appreciate, the aspects of the embodiments has no “analog equivalent” as its embodiments reside solely or substantially in the physical device or computer domain. That is, managing the inventory of numerous wine bottles that can be stored over vast areas, as well as integrating the inventory information with collected wine information, much of which can only be obtained electronically, means using practical, non-abstract physical devices. The technological improvement of the aspects of the embodiments resides in at least in the ability to quickly and easily integrate wine bottle storage information from a wine bottle storage area and related and relevant wine information from numerous and disparate sources, some of which can only be obtained electronically.

In addition, such aspects of the embodiments have no “analog equivalents” because the various aspects of the embodiments' algorithm not only can detect wine bottles and labels and wine bottle storage locations from a distance and automatically, but can combine the electronically obtained storage information with relevant wine information that is, in many cases, only obtained through electronic means, and allows users to obtain and search the combined wine information using many different types of commands none of which could be accomplished without a computer or some other technological equivalent.

FIG. 1 illustrates a conceptual, non-limiting, block diagram of a computing network environment for managing wine bottle inventory and storage according to aspects of the embodiments.

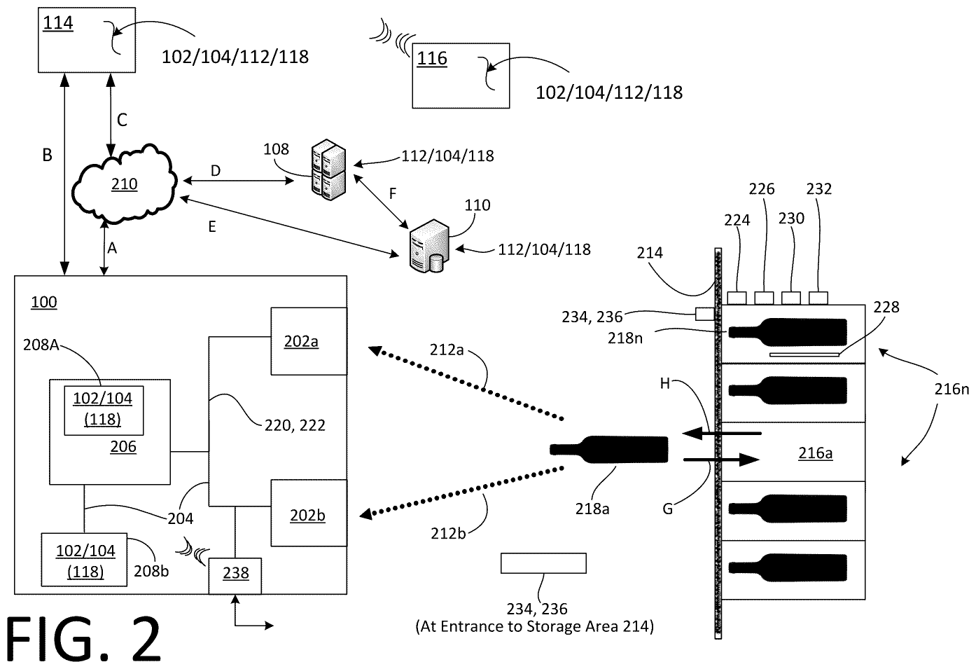

The computing network of FIG. 1 for managing wine bottle inventory and storage includes wine bottle tracking system 100, wine bottle tracker management server 114, network 106, wine information and tracker management server (wine information server) 108, wine information and tracker database server (wine database server) 110, and mobile device 116, according to aspects of the embodiments. Wine bottle tracking system 100 is described in greater detail below in FIG. 2. Wine bottle tracking system 100 comprises, among other items, wine bottle tracker application (tracker App) 102 and wine DB record 104. Wine DB record 104 is shown and described in greater detail below in regard to FIG. 7. Wine information server 108 comprises, among other items, wine information and tracker application (wine Inf. App) 112 and can include wine DB record 104, and wine DB server 110 comprises, among other items, wine Inf. App 112 and can include wine DB record 104 according to aspects of the embodiments.

As shown in FIG. 1, wine tracking system 100 can execute tracker App 102 that alone, or in combination with wine Inf. App 112, provides the capability perform wine bottle tracking functions and wine bottle inventory management.

Wine tracking system 100 can interface with one or more of tracker management server 114, wine inf. server 108 and wine DB server 110 either directly or through network 106, and each can execute and interact with their respective applications (102, 112) and wine DB record 104 either separately, or together in conjunction with each other, to perform wine bottle tracking in one or more wine storage areas, and also perform wine bottle inventory management operations, as well as others as discussed and described both above and below, according to various aspects of the embodiments. Wine tracking system 100 is described in greater detail below, in regard to FIG. 2.

Wine DB records 104, created by wine tracking system 100 and tracker App 102, can be modified and/or edited by wine Inf. App 112, and stored in one or more of devices 100, 114, 108 and 110 according to aspects of the embodiments, among other devices not shown.

Users can access either or both of tracker App 102 and wine Inf. App 112 through wine tracking system 100, wine tracker server 114, wine info server 108, and/or wine DB server 110. According to aspects of the embodiments, however, tracker App 102 obtains wine bottle information as described in greater detail below directly from the wine bottle itself using one or more of cameras and laser transceiver systems, and wine Inf. App 112 obtains other type of wine data not directly obtainable from a wine bottle and also combines the wine related and relevant assembled information into wine DB record 104: for the purposes of this discussion, from hereon in, tracker App 102 will be discussed as the programmed application means for obtaining wine bottle information directly from the wine bottle, and wine Inf. App 112 will be discussed as the programmed application means for assembling wine DB record 104 and for obtaining other relevant and related wine information from sources other than the wine bottle.

Network 106 can be one or more different or separate networks, and can provide wired or wireless communications between nodes, such as tracking systems 100 (of which there can be more than one in one or more wine bottle storage area), wine tracker server 114, wine info. server 108, and wine DB server 110. Each of the aforementioned computing devices 100, 114, 108, and 110 can each include a display device, such as a touch enabled display component, and a monitor, among others, to provide access to either or both of tracker App 102 and wine info. App 112 for the users through a web browser (thin client) or a local client application (thick client). Tracking system 100 and wine tracker server 114 can include a desktop computer, a laptop computer, a tablet, a handheld device, a vehicle mount computer, an embedded computer system, a smart phone, and a wearable computer, among other computing devices, for example.

While computing network environment 100 as illustrated in FIG. 1 has been described with specific components including servers 108, 110, tracking system 100, wine tracker server 114, network 106, tracker App 102 and wine info. App 112, aspects of the embodiments are not limited to these components or system configurations and can be implemented with other system configuration employing fewer or additional components.

Aspects of the embodiments, as described below in reference to the Figures provided herein, provide at least the following functions to overcome the problems in prior art solutions for wine bottle inventory and storage management control.

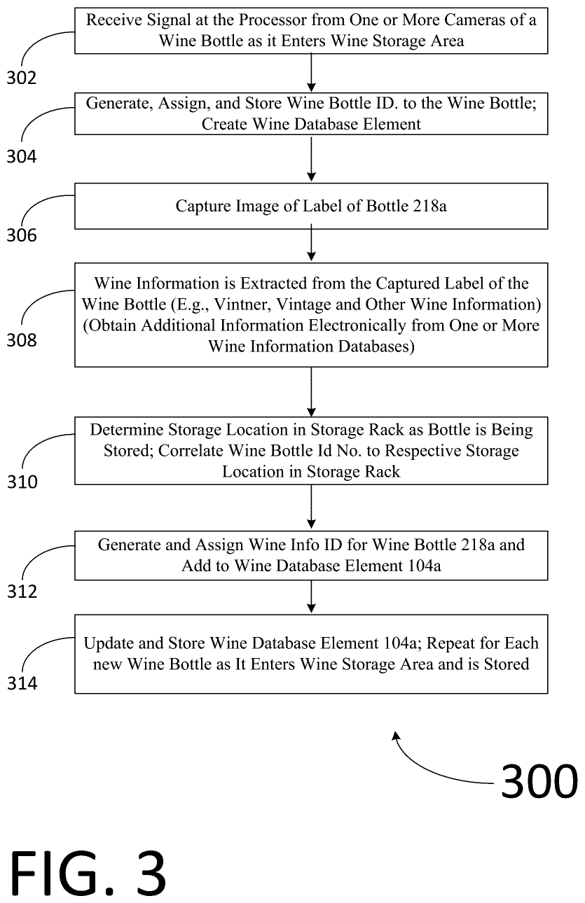

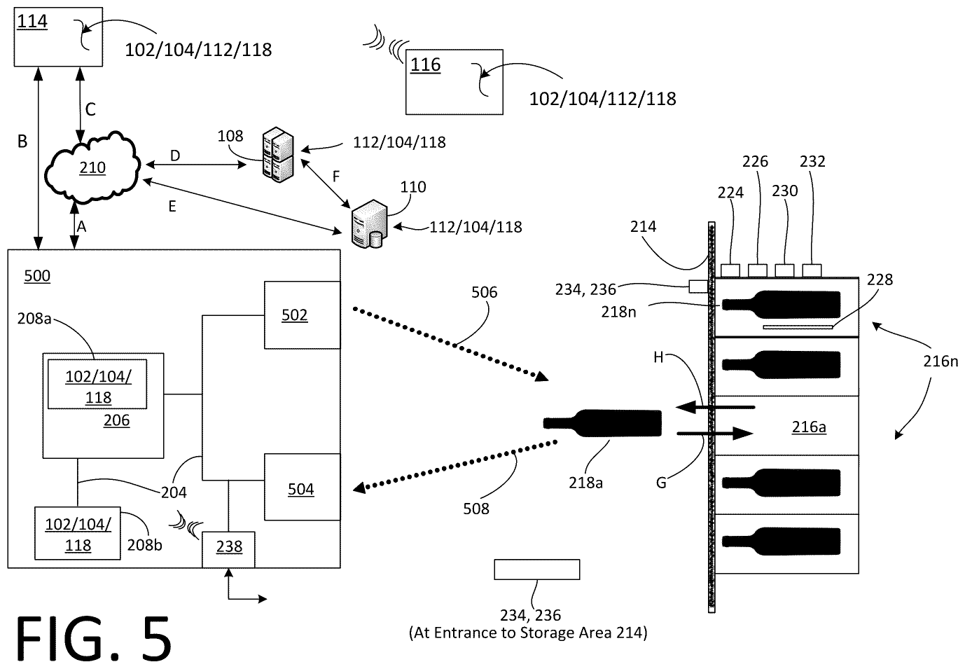

According to aspects of the embodiments, an alpha-numeric identifier, designated as a Wine Bottle Identification (Wine Bottle ID) can be created by one or more of tracker systems 100, 500, tracker App 102, and wine inf. App 112. That is, Wine Bottle ID is a designator that identifies wine bottle 218 based on its label. Information on the label can be extracted by cameras 202, 502, 504 to identify the content of a particular wine bottle 218. According to further aspects of the embodiments, the systems (as shown and described in regard to FIGS. 2 and 5) and methods (as shown and described in regard to FIGS. 3, 4 and 6) described herein can extract a number of image features from the label that can subsequently be used to find a match from a database storing label images of different wine types. Wine bottle 218 can then be identified by finding the closest match from the database (stored as wine DB element 104, and stored in any one or more of devices 100, 108, 112 and 500.

According to aspects of the embodiments, a combination of low-resolution and high-resolution cameras 202 can be employed discern the image content of a label of wine bottle 218. Computationally light object detection techniques can be used that run efficiently on the video feeds from low-resolution cameras to detect and track the labels on wine bottle 218. These low-resolution cameras 202 can detect the labels of wine bottles 218 in substantially real-time when they are visible and not occluded. As soon as a visible label is detected by these low-resolution cameras 202 and the light object detection algorithms that are part of tracker App 102, one or more high-resolution cameras 202 (which can include zoom functions) are commanded to take a close and high-resolution image of the label for further image processing and identification.

According to further aspects of the embodiments, another alpha-numeric designator can be generated, referred to as Bottle Location ID. In this case, the systems (100, 500) and methods described herein (300, 400, and 600) can identify the location where wine bottle 218 is stored in wine storage area 214 by tracking the movements of wine bottle 218 within wine storage area 214. The systems (100, 500) and methods (300, 400, and 600) described herein accomplish this by employing computer vision techniques including classification. object detection and tracking algorithms, all of which are described in greater detail below, and which identify the location where each new wine bottle 218 is stored in wine storage area 214 and automatically save that location into the inventory database (referred to as wine DB element 104).

As discussed above, there are currently no existing systems that are capable of identifying the location of stored wine bottles 218 in wine storage area 214 using computer vision techniques. It can be appreciated by those of skill in the art that application of object detection and tracking techniques for detection and tracking wine bottles in a cellar with potentially thousands of similar objects is far from trivial. Existing object detection algorithm cannot provide the required accuracy (in terms of mean average Precision and mean average Recall) when there are thousands of objects located with very close proximity in the image. According to aspects of the embodiments, systems 100, 500, and methods 300, 400, and 600 as described herein improve the accuracy through the use of one or more of stereo vision and depth estimation techniques to detect changes in scene depth when wine bottle 218a is placed or removed and complement object detection results. As those of skill in the art can appreciate, prior art systems are faced with challenges when it comes track wine bottles 218. Currently available tracker algorithms find it difficult to track a wine bottle 218a when it passes in front of another similar object, e.g., another bottle in the vicinity or the background, because existing tracker algorithms and methods can lock on a similar object in the vicinity or background and stop tracking the object of interest. Aspects of the embodiments, as described in reference to systems 100, 500, and methods 300, 400, and 600, utilize movements of the human who is in wine storage area 214 and how they interact with wine bottles 218. According to further aspects of the embodiments, systems 100, 500, and methods 300, 400, and 600, as described herein focus and identify on certain body parts, such as the shoulders, elbows, and hands of the person as they interact with wine bottles 218. That is, systems 100, 500, and methods 300, 400, and 600 can more readily detect and analyze movement of a particular wine bottle 218 by detecting and analyzing movements of one or more of the shoulders, elbows, and hands of the person moving the particular wine bottle 218a. According to aspects of the embodiments, the systems and methods described herein combine tracking of wine bottle 218 movements and detection of the aforementioned body parts to reliably track each wine bottle 218 that is stored in or removed from wine storage area 214. According to further aspects of the embodiments, by tracking only a few larger objects, such as people in wine storage area 214 makes the task of tracking much simpler.

According to further aspects of the embodiments, the systems (100, 500) and methods (300, 400, and 600) described herein can also perform an inventory search of stored wine bottles 218 within wine storage area 214. By way of a non-limiting example, system 500 can use a coherent light beam to illuminate a particular wine bottle 218a so that a user is directed to its location (e.g., bin 216a) directly (e.g., the user can follow transmitted coherent light 506, discussed in greater detail below). According to aspects of the embodiments, one or more users can interface with one or more systems 100, 500 and tracker App 102 and/or wine inf. App 112 to perform search functions (e.g., Boolean search functions) on wine DB record 104 to find a particular wine, and system 500 can point to the particular wine bottle 218a. According to aspects of the embodiments, system 500 can point out an item in inventory using an automated laser pointer and based on images of the inventory capture the location of each item. According to further aspects of the embodiments, such mapping and search functions can be used to map the storage locations (bins 216) or a plurality of wine bottles 218 within wine storage area 214. According to still further aspects of the embodiments, a first camera feed (from mobile device 116) can be overlaid on one or more existing images and contents of wine storage area 214 to identify the location of a particular wine bottle 218a on the handheld device camera feed.

Mobile device 116 is also shown in FIG. 1 as accessing network 106, and can interface with devices 100, 114, 108, and 112; mobile device 116 contains modified tracker App 102 as described in greater detail below, as a means for searching for inventory, such as a wine bottle, in a wine storage area. Such search means and other aspects of modified tracker App 102′ are described in greater detail below.

According to aspects of the embodiments, one or more of systems 100, 500 and methods 300, 400, and 600, described below, can update the inventory of wine bottles 218 as they are added and removed from wine storage area 214. Use of substantially similar wine bottle 218 detection and tracking algorithms as describe above (and below, in greater detail), can be employed to track movement of wine bottle 218 and update the inventory after any wine bottle 218 is added and/or removed from wine storage area 214. According to further aspects of the embodiments, as the any one or more of wine bottles are removed from wine storage area 214, the systems and methods described herein can obtain additional wine-related information to ascertain the most currently available status of the wine—such as pricing and availability—as wine, like many other commodities, can change value rapidly. The additional wine related information can be obtained from any one or more of private re-sellers (e.g., traders, collectors, and the like), commercial wine information databases, news information databases, legal information databases, and the like.

FIG. 2 illustrates a detailed block diagram of wine bottle tracking system (tracking system) 100 operating within the network of FIG. 1 according to aspects of the embodiments. Tracking system 100 includes first and second optical detectors (cameras) 202a,b, although, as those of skill in the art can appreciate, there can be one or more than two such cameras 202 within tracking system 100. Cameras 202 (cameras 202, as those of skill in the art can appreciate, output one or more analog signals that are then converted to digital signals via an analog-to-digital converter), can be transmitted digitally by internal bus 204 to controller/processor (processor) 206. According to further aspects of the embodiments, cameras 202a,b are shown as physically being part of tracker system 100, although that need not necessarily be the case; that is, according to aspects of the embodiments, one or more of cameras 202 can be remotely located from processor 206, and can transmit their respective signals via a wired or wireless interface. According to still further aspects of the embodiments, processor 206 and memory 208, in whatever form that it is embodied in, can be remotely located, communicating with cameras 202a,b through network 210. Processor 206 can include internal memory 208a, and/or can access externally memory 208b (collectively referred to as “memory”). Stored within each or both or just one of memory 208 is tracker App 102, in the manner described above. Tracker App 102 contains the programmed instructions to receive and process optical images (camera output signal 220) from the one or more cameras 202a,b, as well as control cameras 202, if they are controllable (via camera control/command signals 222), provide and interface to one or more users, whether locally or remotely (through network 106, or via a direct connection, or other communications means).

Cameras 202a,b capture one or more images/videos of wine bottle 218a as it is being stored (Arrow G) and/or removed (Arrow H) from wine storage area (rack) 214, and a particular wine storage bin (bin) 216a and generate image information that is output as camera output signals 220. Camera output signals 220 are sent to and received by processor 206 for processing. Processor 206 analyzes the captured received one or more images/video contained in camera output signals 220 from cameras 202 and extracts the bottle's wine information by processing the label images/video signals. According to aspects of the embodiments, one or more of cameras 202 can be a low-resolution camera, or a high-resolution camera, a video camera, a still image only camera, or any combination thereof.

Processor 106 and tracker App 102 then generate three separate identifiers for each wine bottle 218a: wine bottle identification (shown in FIG. 7 and stored in wine DB record 104 as Wine Bottle ID 702a); location identification (shown in FIG. 7 and stored in wine DB record 104 as Bottle Location ID 702b); and wine information identification (shown in FIG. 7 and stored in wine DB record 104 as Wine Info ID 702c).

According to aspects of the embodiments, Wine Bottle ID 702a is a unique identifier for each wine bottle 218 in the inventory. Wine bottle ID 702a associates a unique alphanumeric identification to information for each wine bottle 218 stored in the database. According to aspects of the embodiment, Bottle Location ID 702b is a unique identifier for each storing location in the inventory. Bottle Location ID 702b associates a unique alphanumeric identification to each location in the inventory. By way of non-limiting example, Bottle Location ID 702b can include information about a particular store, aisle or row, bin location and particular bin number for the stored bottle of wine 218. According to further aspects of the embodiments, Wine Info ID 702c is a unique identifier for wine labels, or wine types, with a unique set of wine information. Wine Info ID 702c associates a unique alphanumeric identification to set of wine information, such as wine brand/winery, the grape type and varietal, the vintage, the vineyard, among other relevant information. Referring to FIG. 7 and wine DB record 104, wine bottle ID can occupy field 702a, location ID can occupy field 702b, and wine info ID can occupy field 702c, though as those of skill in the art can appreciate, this designation is not limiting and can be changed to suit the needs of the proprietor or wine inventory owner. According to further aspects of the embodiments, Wine Info ID 702c can be referred to as a classification of the wine contained in the wine bottle 218a, and can relate one or more of the information in fields 702d-q. That is, Wine Info ID 702c can include wine brand field 702d, vintage 702e, and producer 702f, and each bottle of wine 218 that have those common characteristics would have the same Wine Info ID 702c. Other fields can be substituted and/or included according to further aspects of the embodiments. According to aspects of the embodiments, each time a bottle of wine 218 is stored in wine storage area 214, the systems and methods described herein generate the three ID's described above: Wine Bottle ID 702a, Bottle Location ID 702b, and Wine Info ID 702c. That is, each bottle 218 stored in wine storage area 214 can be referred to by a unique combination of the three IDs 702a,b,c—no two bottles 218 stored in wine storage area 214 will have the same exact combination of IDs 702a,b,c, even if stored in the same bin 216. The additional information stored in wine DB record 104 can be obtained from one or more of wine information databases 118 according to aspects of the embodiments.

By way of a non-limiting example, suppose five bottles of wine 218a-e are added to wine storage area 214; the first two in two separate bins 216a,b, and the remaining three into bin 216c. Then, the respective wine DB records 104 can appear as follows:

### Bottle 218a: Wine Bottle ID:0 Bottle Location ID:0 Wine Info ID:1

### Bottle 218b: Wine Bottle ID:1 Bottle Location ID:1 Wine Info ID:2

### Bottle 218c: Wine Bottle ID:2 Bottle Location ID:2 Wine Info ID:3

### Bottle 218d: Wine Bottle ID:3 Bottle Location ID:2 Wine Info ID:3

### Bottle 218e: Wine Bottle ID:4 Bottle Location ID:2 Wine Info ID:5

Each wine bottle 218a-e has a unique Wine Bottle ID 702a alpha numeric identifier; thus, bottle 218a has Wine Bottle ID 702a of “0”, wine bottle 218b has Wine Bottle ID 702a of “1” and so on. The first two wine bottles 218a,b are stored in separate locations, and hence Bottle Location ID 702b for the first two wine bottles 218a,b are different (“0” and “1” respectively), but the final three are stored in the same bin 216, and thus have identical Bottle Location IDs 702b of “2”. Wine bottles 218c,d are the same type, and so have identical Wine Info ID 702c alpha-numeric identifiers (“3”), but wine bottles 218a,b,e are different from wine bottles 218c,d, and from each other, and therefore have unique Wine Info Id 702c identifiers (“1,” “2,” and “5,” respectively).

As described above, tracker system 100 and tracker App 102 generate and assign a unique bottle identification number (Wine Bottle ID 702a) to each wine bottle 218a as its image is received, and begins the process of generating wine DB record 104, which is a collection of information about each wine bottle 218 that is stored in a respective wine enterprise location's inventory. That is, as each wine bottle 218 is brought into and stored, a unique Wine DB Record 104a (pertaining to wine bottle 218a) is generated and stored by tracking system 100 and tracker App 102 according to aspects of the embodiments. Bottle Location ID 702b is determined and added to the same Wine DB Record 104a. Wine Info ID 702c can be generated and added at substantially any time thereafter, as some of the information for each of the fields 708d-p may not be known at present and may have to be retrieved at a later time, though this need not necessarily be the case.

According to further aspects of the embodiments, cameras 202 comprise at least one or more of a digital camera, a mountable camera, a digital video camera, an infrared camera, and/or a stereovision/depth sensing camera. According to further aspects of the embodiments, wine storage area 214 can be a wine cellar, and according to still further aspects of the embodiments, wine storage area 214 can be at least one or more of a wine cellar, a closet, merchandise shelves of a store, shelves in an inventory or a warehouse, among other locations.

According to further aspects of the embodiments, one or more sensors/devices can be added to system 100 to provide wine bottle detection/security functions, as well as to monitor important environmental parameters, such as temperature and humidity. Such sensors can include, but are not limited to, one or more of motion detector 224, thermometer 226, scale 228, hygrometer 230, accelerometer 232, biometric sensors 234, a physical security devices 236 according to aspects of the embodiments.

Although a detailed discussion of the theory of operation and use of such sensors is both beyond the scope of this discussion, and not needed to understand the various aspects of the embodiments, the following has been included in fulfillment of the dual purposes of clarity and brevity.

According to further aspects of the embodiments, system 100, as shown in each of FIGS. 1, 2, 5, 8 and 9, and which employ one or more of methods 300, 400, and 600, among others, can further include motion detectors 224. Motion detectors 224 can include passive motion sensors, active motion sensors, and combinations thereof. A non-limiting example of a passive motion sensor can include a passive infrared (PIR) type motion sensor. PIR sensors are the most widely used motion in home security systems. Once the PIR motion sensor is warmed up, it can detect heat and movement in the surrounding areas, creating a protective “grid.” If a moving object interferes or enters a gird, the PIR motion sensor is tripped and generates an alert signal. In all of the sensors discussed and described herein, 224, 226, 228, 230 and 232, and any others, the generated alert or status or measurement signal can be transmitted to processor 206 via wired or wireless communications means, as FIG. 2 (and FIG. 5) illustrates. Wired/wireless interface 238 in system 100 can receive the signals/measurements and one or more of Apps 102/104/118 can process the same to generate alerts/alarms/notifications. Such alerts/alarms/notifications are discussed below.

One example of an active motion detector 224 is one that uses a microwave transceiver. The microwave transceiver transmits microwave pulses and measures the reflection off a moving object. Microwave transceivers cover a larger area than infrared sensors, but they are vulnerable to electrical interference and are more expensive. Other examples of active motion detectors 224 are those that can transmit ultrasonic pulses, and infrared light,

An example of a motion detector 224 that combines passive and active technologies is one that use PIR and a microwave transceiver (or any of the other type of active motion sensors). Since each operates in different areas of the spectrum, and one is passive and one is active, such combined or dual technology motion sensors are not as likely as other types to cause false alarms, because in order for the alarm to be triggered, both sensors have to be tripped.

According to further aspects of the embodiments, system 100, as shown in each of FIGS. 1, 2, 5, 8 and 9, and which employ one or more of methods 300, 400, and 600, among others, can further include thermometer 226. Thermometer 226 detects heat in a local environment. Thermometer 226 can serve two purposes according to aspects of the embodiments. A first purpose is to monitor the temperature of bin 216. In fulfillment of that purpose, thermometer 226a does not need to be particularly sensitive to temperature changes that occur over relatively short time periods. Thermometer 226a should, of course, be accurate, but if there were a sudden change in temperature, thermometer 226a, when used only to track the temperature in bin 216 and/or the immediate surrounding area, does not need a particular or relatively fast response time. However, according to a further aspect of the embodiments, a second type of thermometer that is particular sensitive to temperature changes, thermometer 226b, can be used to determine when a person inserts their arm and hand into bin 216 to extract or store wine bottle 218. That is, thermometer 226b can respond very quickly if there is a temperature changes caused by a person extracting one or more bottles of wine from bin 216.

According to further aspects of the embodiments, system 100, as shown in each of FIGS. 1, 2, 5, 8 and 9, and which employ one or more of methods 300, 400, and 600, among others, can further include scale 228. Scales 228 can be used to record and monitor a weight of wine bottle 218 in each bin 216; if one or more bottles 218 are extracted from a bin 216, then system 100 can be alerted to that removal substantially instantaneously. According to further aspects of the embodiments, there can be an individual scale 228 for each bottle 216 in a bin 216, or there can be one scale 228 for the entire bin 216 if the bin 216 can store a plurality of bottles 216.

According to further aspects of the embodiments, system 100, as shown in each of FIGS. 1, 2, 5, 8 and 9, and which employ one or more of methods 300, 400, and 600, among others, can further include hygrometer 230. Hygrometers 230, as those of skill in the art can appreciate, determine the amount of humidity in an environment. Such environmental information can be useful to avoid prematurely drying of corks, or negatively affecting the quality of wine stored in bottle 218. In certain circumstances hygrometer 230 can also be used to detect the presence (or absence) of people in areas as their presence will affect humidity levels. The output of thermometer 226 and hygrometer 230 can be used by an environmental control system to control temperature and humidity in storage area 214 and bins 216 according to aspects of the embodiments.

According to further aspects of the embodiments, system 100, as shown in each of FIGS. 1, 2, 5, 8 and 9, and which employ one or more of methods 300, 400, and 600, among others, can further include accelerometer 232. Accelerometers 232 can detect vibrations and/or motion in and around bins 216; such information can be used to determine when bottles 218 are placed into, or extracted from, bins 216 according to aspects of the embodiments. Accelerometers 232 can be placed in each of three different axes in order to maximize detection capabilities.

As briefly described above, each of sensors 224, 226, 228, 230, and 232 can generate analog and/or digital signals that can be used by one or more of Apps 102, 104, 112, 118 to monitor environmental conditions within storage area 214, detect the placement of, or extraction of bottles 218 into bins 216, and also to detect the presence of one or more people in storage area 214 or in proximity to bins 216 according to aspects of the embodiments. Such information, especially that information regarding the placement and extraction of bottles 218 can be used for inventory control/billing purposes, among others. For example, when one or more of such sensors detect the placement of a bottle, such output can trigger or verify the output of optical detector 202 and/or coherent light transmitters/receivers 502/504, in a manner as described in detail in regard to FIGS. 2, and 5, respectively (e.g., methods 300, 400, and 600, as well as updating wine information storage database record fields 702). By way of non-limiting example, the combination of these sensors and methods and system 100 can determine what particular person or person added or extracted bottle 218 into or out of storage area 214 and/or bin 216 according to further aspects of the embodiments.

According to further aspects of the embodiments, system 100, as shown in each of FIGS. 1, 2, 5, 8 and 9, and which employ one or more of methods 300, 400, and 600, among others, can further include security devices, which can be generally divided into biometric sensors 234 and physical security devices 236. Security devices can be located at an entrance to storage area 214 (e.g., the door leading into a wine cellar), and/or security devices can also be located at one or more of individual bins 216, especially for relatively valuable/expensive bottles 218.

Biometric sensors 234 can include one or more of fingerprint scanners, iris scanners, and facial recognition devices, among other types, to verify that the person entering storage area 214 and/or accessing a particular bin 216 is person authorized to be in the area or to handle the bottle(s) 218 (owner, qualified purchases, administrator, employee, among others). In a substantially similar manner, physical security devices 236 operate to preclude entrance to storage area 214 and/or bins 216. Such physical security devices 236 can include one or more of magnetic strip readers, integrated chip readers, keys, cypher locks, Fobs, and the like. Each of the security devices described above (234, 236), and those not specifically mentioned, can provide security to storage area 214 and/or bins 216, and can generate digital/analog signals that can be transmitted via hard wire or wirelessly and received by processor 208 via interface 238, and used by one or more of Apps 102, 104, and/or 118, in a substantially similar manner as the outputs of sensors 224, 226, 228, 230 and 232 as described above.

FIG. 3 illustrates a flow diagram of method 300 for capturing information about wine bottle 218 as it is stored in wine storage area 214, and storing the same, along with other relevant related wine information according to aspects of the embodiments.

Method 300 begins with method step 302, in which a signal is generated by one or more of cameras 202a,b and received by processor 206 and tracker App 102, as wine bottle 218a is brought into wine storage area 214.

In method step 304 Wine Bottle ID 702a is generated and assigned to wine bottle 218a and is stored in wine DB record 104, which can also be substantially simultaneously generated, or already existing. In method step 306, processor 206 and tracker App 102 retrieves and captures the label of wine bottle 218a. According to aspects of the embodiments, optical character recognition (OCR) can be performed on the label of wine bottle 218a, among other techniques (image processing, among others) to obtain information from the label.

As those of skill in the art can appreciate, there exist numerous wine bottle label recognition techniques and algorithms that can be used to assist in this step. By way of non-limiting example, one such technique is discussed in “Mobile Wine Label Recognition,” by T. Gebru, et al., Dept. of Electrical Engineering, Stanford University, Stanford CA, 94305, the contents of which are incorporated in their entirety herein.

In method step 306 tracker App 102 can process the received images and use several techniques to first find wine bottle 218a as it is introduced, then read the label. To find the new wine bottle 218a, tracker App 102 can focus and identify on certain body parts, such as the shoulders, elbows, and hands of the person as they interact with wine bottles 218. That is, tracker App 102 can more readily detect and analyze movement of a particular wine bottle 218 by detecting and analyzing movements of one or more of the shoulders, elbows, and hands of the person moving the particular wine bottle 218a. According to aspects of the embodiments, the systems and methods described herein combine tracking of wine bottle 218 movements and detection of the aforementioned body parts to reliably track each wine bottle 218 that is stored in or removed from wine storage area 214. According to further aspects of the embodiments, by tracking only a few larger objects, such as people in wine storage area 214 makes the task of tracking much simpler.

In method step 308 wine information is extracted from the captured label of wine bottle 218a. Such wine bottle information can include one or more of wine brand, vintner, vintage, producer, grape type and varietal, designation, vineyard, country, region, subregion, appellation, alcohol percentage, price, reviews and ratings, food pairing, and taste characteristics: this information can be stored in wine DB record 104a (for wine bottle 218a), in one or more tracker system 100, wine tracker server 114, wine info server 108, and/or wine DB server 110. Wine DB element 104a is substantially similar to that as shown in FIG. 7, wherein each of the different components of wine information are stored in respective ones of fields 702d-q according to aspects of the embodiments. According to further aspects of the embodiments, the information that was obtained from the label of wine bottle 218a can be supplemented by wine information that can be obtained electronically or checked for veracity and updated information.

In method step 310, a storage location is obtained from the captured image information as wine bottle 218a is stored in wine storage area 214. By way of non-limiting example, as shown in FIG. 2, wine bottle 218a is being stored in wine storage bin 216a of wine storage area 214, which in this non-limiting case is a wine rack in a wine cellar. In this case, Bottle Location ID 702b can include one or more of the bin number, the rack number, the location in the image of the rack, and can include other information, if necessary, such as which wine cellar, or which portion of a store, or which portion of a warehouse, and similar other information, as needed.

In method step 312, processor 206 and tracker App 102 can generate and assign Wine Info ID 702c to wine bottle 218a for the extracted information and associates Wine Info ID 702c with the corresponding Wine Bottle ID 702a. In method step 314, wine DB record 104a is updated and stored.

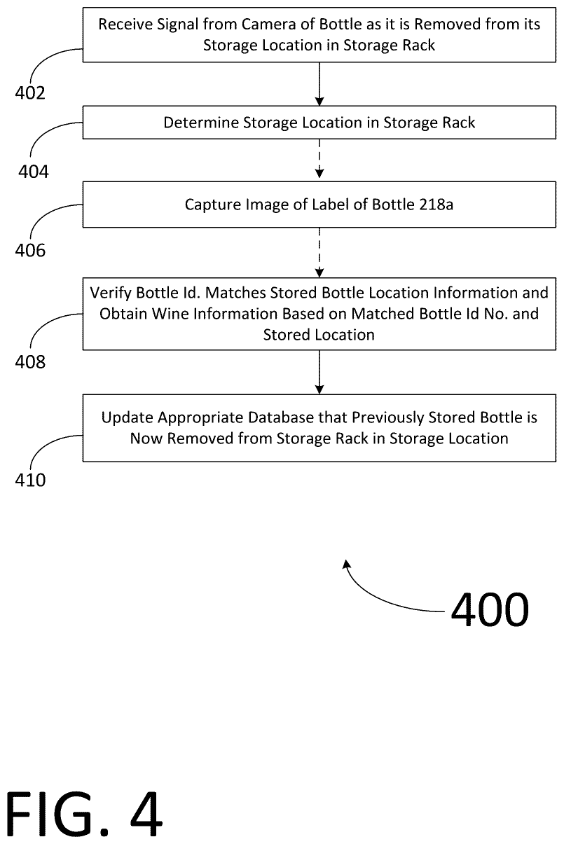

FIG. 4 illustrates a flow diagram of method 400 for capturing information about wine bottle 218 as it is retrieved from wine bottle storage area 214 and updating wine DB record 104 according to aspects of the embodiments.

According to aspects of the embodiments, processor 206 and tracker App 102 can track the retrieval of an existing/stored wine bottle 218a from the wine cellar, automatically identifying the information of the wine bottle stored in the identified location in the automated system and updating the inventory content (removing the bottle from the system). As in the case of storage of wine bottle 218a, one or more cameras 202 can be used to track the retrieval of wine bottle 218a from the bine in the storage rack in the wine cellar (Arrow H in FIG. 2, showing the retrieval of wine bottle 218a).

Method 400 begins with method step 402 as wine bottle 218a is retrieved. In step 402, the signal from one or more cameras 202 is received by processor 206 and tracker App 102 and in method step 404 its storage location is also determined; processor 206 and tracker App 102 can then obtain its Bottle Location ID to find the particular wine DB record 104a that pertains to this wine bottle 218a.

Method steps 402 and 404, as with steps 302 and 304 while performed substantially continuously, can nonetheless require additional processing techniques according to various aspects of the embodiments. That is, tracker App 102 can process the received images and use several techniques to first find wine bottle 218a as it is introduced, then read the label. To find the new wine bottle 218a, tracker App 102 can focus and identify on certain body parts, such as the shoulders, elbows, and hands of the person as they interact with wine bottles 218. That is, tracker App 102 can more readily detect and analyze movement of a particular wine bottle 218 by detecting and analyzing movements of one or more of the shoulders, elbows, and hands of the person moving the particular wine bottle 218a. According to aspects of the embodiments, the systems and methods described herein combine tracking of wine bottle 218 movements and detection of the aforementioned body parts to reliably track each wine bottle 218 that is stored in or removed from wine storage area 214. According to further aspects of the embodiments, by tracking only a few larger objects, such as people in wine storage area 214 makes the task of tracking much simpler.

Optional method step 406 follows method step 404. In method step 406 the image of the label of the retrieved wine bottle 218a can be analyzed using OCR or other image processing techniques. Step 406 can be used in cases in which Bottle Location ID 702b is difficult to ascertain, such as when there are multiple bottles 218 in a single bin 216, and they can shift and move as a first bottle 218 is retrieved. Another reason it might be difficult to determine Bottle Location ID 702b can be that the person removing the bottle 218 can occlude the view of the camera such that there is no view of the particular bin 216 as bottle 218 is removed from it. Those of skill in the art can appreciate that other reasons can exist in which the location of the bottle cannot be accurately determined when the bottle is removed from its storage bin. As those of skill in the art can appreciate, there exist numerous wine bottle label recognition techniques and algorithms that can be used to assist in this step. By way of non-limiting example, one such technique is discussed in “Mobile Wine Label Recognition,” by T. Gebru, et al., Dept. of Electrical Engineering, Stanford University, Stanford CA, 94305, the contents of which are incorporated in their entirety herein. In method step 408, processor 206 and tracker App 102 verify that the wine bottle information obtained from the wine bottle label in step 406 is compared to the information in wine DB record 104a. If the information does not match, then method 400 attempts to retrieve another image of the wine bottle label; this can be accomplished by reviewing additional images of the wine storage area 214, or by requesting a particular view of wine bottle 218a by the person handling wine bottle 218a. In method step 410, wine DB record 104a is updated with the information that wine bottle 218a has been removed from bin 216a and the respective wine storage area 214.

According to further aspects of the embodiments, one or more of the following actions can be performed along with, in place of, or in addition to the steps outlined in FIG. 4 and method 400. For example, according to aspects of the embodiments, the retrieval of the bottle from a location in the wine cellar can tracked using one or more cameras 202. According to aspects of the embodiments, the one or more cameras 202 used for tracking the placement of wine bottle 218 are the same as cameras 202 used for capturing the wine bottle label. According to aspects of the embodiments, the tracking and capturing the retrieval of wine bottle 218 from its bin 216 in the wine cellar is augmented by the following steps, wherein one or more of the steps and the order of the steps are optional: one or more low-resolution and/or no-zoom cameras 202 can track the movement of wine bottle 218 and its removal from its storage location 216a in wine storage area 214. According to aspects of the embodiments, the tracking can be stopped when wine bottle 218a is outside of its stored location 216a. According to aspects of the embodiments, the location of stored wine bottle 218a can be identified from the images/videos captured by the one or more cameras 202, and the identified Bottle Location ID can be used to retrieve the associated Wine Bottle ID and Wine Info ID for wine bottle 218a from tracking system 100 and tracker App 102. According to aspects of the embodiments, the information associated with the Bottle Location ID is updated in wine DB record 104a, wherein the stored record corresponds to the Wine Bottle ID and Wine Info ID associated with the identified Bottle Location ID. According to aspects of the embodiments, tracking system 100 and tracker App 102 verify that wine bottle 218a and its corresponding Bottle Location ID are identified in the previous steps are correct and consistent with the inventory.

According to aspects of the embodiments, the verification step comprises the step of scanning the retrieved wine bottle 218a. Tracking system 100 and tracker App 102 can identify wine bottle 218a via a scan of its label, looks up its location stored in wine DB record 104a and compare this location with the location obtained from the tracking cameras 202 in the previous steps. By doing so, tracking system 100 and tracking App 102 can verify that wine DB record 104a corresponds to the correct wine (and its corresponding location) stored in wine storage area 214.

According to aspects of the embodiments, if the identified location is wrong, the user will be notified using a sound alarm, a notice on the user interface of the automated tracking system or a voice notice. According to aspects of the embodiments, in steps 402-406, a high-resolution camera 202 can takes an image/video from wine storage area 214 after wine bottle 218a is retrieved. The high-resolution image/video can be used in later steps of method 400 for location identification.

According to aspects of the embodiments, the image/picture of wine storage area 214 includes a camera view of wine storage area 214, which can be, by non-limiting example, a wine cellar. According to aspects of the embodiments, the images of the wine cellar includes or incorporates multiple camera views, from different angles and/or locations.

According to aspects of the embodiments, the comparison between the views/images of wine storage area 214 before and after retrieval of wine bottle 218a can be performed by comparing the image of wine storage area 214 prior to retrieval of wine bottle 218a, and the image of wine storage area 214 following retrieval of wine bottle 218a. According to aspects of the embodiments, the comparison can be performed by creating a difference between the before and after images, wherein the difference image can indicate the location of stored wine bottle 218a (bin 216a).

According to aspects of the embodiments, in order to mitigate the impact of shades and lightings, slight camera movement and differences in pixel readings from sensors with cameras 202, the difference between the images are not a pixel-by-pixel difference, but are instead determined by one or more image processing algorithms or other image processing techniques such as: Applying some background and foreground segmentation techniques to identify areas that might have changed between the two images; Comparing the content and the texture of the images for these suspected areas; and Applying a wine bottle image detector and/or classifier to these areas to confirm addition or removal of a wine bottle is causing the change, and extracting some image features for these suspected areas and measuring the distance between the image features to confirm the change in content. According to aspects of the embodiments, one or more of a stereovision camera, depth sensing camera, and Light Detection and Ranging (LIDAR) device can be utilized to detect changes in the depth of certain areas in the before and after images to verify storage and retrieval of wine bottle 218a.

FIG. 5 illustrates a detailed block diagram of wine bottle tracking system (tracking system) 500 utilizing coherent light transmitter 502 and coherent light detector 504 and operating within the network of FIG. 1 according to aspects of the embodiments.

Tracking system 500 includes many of the same components as tracking system 100 shown in detail in regard to FIG. 2, and operates with the same network components, as can be seen in FIG. 5, as tracking system 100 does, as shown in FIGS. 1 and 2. In addition, tracking system 500 can operate in a substantially similar manner as tracking system 100, and therefore, in fulfillment of the dual purposes of clarity and brevity, a detailed discussion of substantially similar components, features, and capabilities have been omitted from this discussion of tracking system 500 in regard to FIG. 5. In addition, tracker App 102 and wine DB record 104 are also substantially similar, although there are additional capabilities present within tracking system 500 as described herein below, that can be utilized effectively by a slightly different version of tracker App 102; however, it could be the case that a “global” version of tracker App 102 can be used in both tracker systems 100,500 but certain features would not be useable in tracker system 100, as will be appreciated from the following discussion.

Tracker system 500 differs from tracker system 100 in terms of components in regard to cameras 202 have been replaced by coherent light transmitter 502 and coherent light detector 504. According to aspects of the embodiments, coherent light transmitters are lasers, and the detectors are fabricated to receive the particular light wavelengths used by the transmitter 502; that is, detector 504 is “tuned” to the frequency/wavelength of transmitted coherent light 506 and reflected coherent light 508. Light beams 506, 508 are substantially similar but will have minor variations due to doppler effects, as those of skill in the art can appreciate.

There are multiple uses for tracking system 500 and tracker App 102. In a first use, tracking system 500 and tracker App 102 can generate light signals to point a user/consumer to a particular location where a particular wine bottle 218a is located. That is, according to aspects of the embodiments system 500 and tracker App 102 have the ability to point/guide the user to a particular location (for helping him/her locate the bottle he/she is looking for) using transmitted coherent light beam 506. By way of non-limiting example, a user can enter a desired type of wine, or other identifying information through a search feature in tracker App 102 and if such wine exists in the inventory, system 500 and tracker App 102 can point to the particular bottle 218 in storage area 214 and bin 216. According to further aspects of the embodiments, system 500 and tracker App 102 can provide direction, either visually (follow the beam), or through written/audio instructions. According to further aspects of the embodiments, system 500 and tracker App 102 can interface with a mobile device 116 used by the user and provide directions on mobile device 116 (a moving map and/or audio) and point to the desired bottle with the light beam 506.

According to further aspects of the embodiments, system 500 and tracker App 102 can also update wine DB record 104 when a bottle 218a has been removed from the inventory. System 500 and tracker App 102 can analyze the one or more images/video signals captured and received from detector 504 (in addition, other types of optical detectors can be used, but are not shown in FIG. 5), and identifies the location and Bottle Location ID 702b of the retrieved wine bottle 218a. Tracking system 500 and tracker App 102 retrieve Wine Bottle ID 702a and Wine Info ID 702c from wine DB record 104 for the retrieved wine bottle 218a associated with the identified location and make necessary updates to the inventory (wine DB record 104) for that Wine Bottle ID. According to aspects of the embodiments transmitter 502 and detector 504 can include one or more of a digital camera, a mountable camera, a digital video camera, an infrared camera, and/or a stereovision/depth sensing camera. According to aspects of the embodiments the target location is wine storage area 216, and wine storage area 214 can further include at least one of a wine cellar, a closet, merchandise shelves of a store, shelves in an inventory or a warehouse.

According to aspects of the embodiments, transmitter 502 projects an optical visible or invisible light beam (transmitted coherent light) 506 onto a target location 216a, which is being pointed/beamed at. Transmitted coherent light 506 comprises at least one or more of a laser beam or any form of coherent visible light beam. Detector 504 receives reflected coherent light 508 and from that generates one or more of a video/image from the target location 216a. Detector 504 comprises at least one or more of a digital camera, a mountable camera, a digital video camera, an infrared camera, and/or a UV camera. According to aspects of the embodiments, the target location can be wine storage area 214, and can include substantially any location where transmitted light beam 506 can be projected on. According to aspects of the embodiments, the target location 216a comprises at least one or more of a wine cellar, a closet, merchandise shelves of a store, shelves in an inventory or a warehouse.

As discussed above, tracking system 500 includes substantially similar devices, capabilities, and features as tracking system 100, and therefore they will not be discussed again in fulfillment of the dual purposes of clarity and brevity. In addition, tracking system 500 and tracker App 102 can analyze the received video/still image signals and provide control commands to transmitter 502 in order to steer transmitted light 506.

According to aspects of the embodiments, the control commands to transmitter 502 comprises of commands to turn/shift the light beam to a given direction (up, down, left, or right). According to aspects of the embodiments, the control commands specify the amount of optical beam movement or shift in each direction. According to aspects of the embodiments, the control commands specify the amount of optical beam movement/shift in degrees (e.g., 5 degree left), or in steps (e.g., 5 steps up), and/or in inches/centimeters/millimeters. According to aspects of the embodiments, the control commands can include commands to increase/decrease the power of the light signal being transmitted (transmitted light beam 506), as well as a beam width, among other transmission characteristics.

As discussed above in regard to FIGS. 1 and 5, and as well as in regard to the methods described herein, aspects of the embodiments can incorporate several different types of cameras-low-resolution cameras, high-resolution cameras, laser transmitters (LIDAR), and the aspects of the embodiments can further incorporate and use other types of cameras, such as depth sensing cameras, time of flight type cameras, color cameras (red-green-blue (RGB)), and USB cameras. As such, the following paragraphs include a non-limiting, non-exhaustive list of such cameras (and includes links to find additional information, all of which are incorporated herein by reference).

Examples of LIDAR and laser range finder (LRF) cameras can include the following: Velodyne PUCK (https://velodynelidar.com/vlp-16.html); SLAMTEC RPLIDAR A3

(https://cdn.sparkfun.com/assets/2/5/a/c/5/LD310_SLAMTEC_rplidar_datasheet_A3M1_v1.2_en.pdf)

Examples of Depth sensing cameras can include the following: Intel RealSense D415 (https://www.intelrealsense.com/depth-camera-d415/) and D435 (https://www.intelrelease.com/deptch-camera-d435i/), Stereo Labs ZED (https://stereolabs.com/zed/), and DUO MC (https://duo3d.com/#).

Examples of time of flight type of cameras can include the following: BASLER Blaze (https://www.baslerweb.com/en/products/cameras/3d-cameras/basler-blaze/)

Examples of RGB color cameras, with different resolutions and with Gigabit Ethernet interface, or USB 2/3 interface, can include Industrial and non-industrial types as in the following:

Examples of matrix vision industrial cameras, with several different resolutions, can include the following: (https://wwwmatrix-vision.com/camera-selector.html), BASLER Ace Series industrial cameras (https://www.baslerweb.com/en/products/cameras/area-scan-cameras/ace/#productline=aceclassic), Teledyne Gene Nano industrial cameras (https://www.teledynedalsa.com/en/products/imaging/cameras/genie-nano-1gige/).

Examples of USB webcams (non-industrial) can include the following: https://www.amazon.com/ELP-Varifocal-8Megapixel-Android-Industrial/dp/B07F9Q5WZ4/ref=sr_1_3?keyboards=USB+K+camera&qid=1576190317&sr=8-3, and a 1080p example: https://www.amazon.com/Logitech-C920S-Webcam-Privacy-Shutter/dp/B07K95WFWM/ref=sr_1_4?keyboards=USB+4K+webcam&qid=1576190258&sr=8-4, among many others.

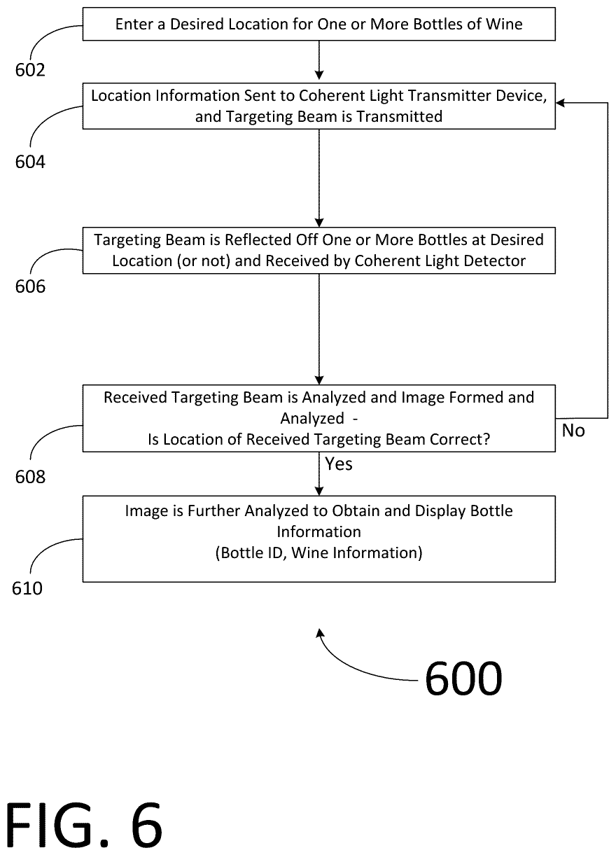

FIG. 6 illustrates a flow diagram of method 600 for using tracking system 500 of FIG. 5 to determine a status of a particular wine bottle storage area location (wine storage bin 216) according to aspects of the embodiments. Method 600 begins with method step 602, in which an input is received by tracking system 500 and tracker App 102 indicating the desired location that transmitted light beam 506 should be aimed at. In some embodiments, the location to be pointed/beamed at, is provided by a coordinate. In step 604, tracking system 500 and tracker App 102 send location information to transmitter 502 and commands it to shine/beam light beam 506 at the desired location. In method step 606, transmitted light beam 506 is reflected off either or both of wine bottle 218a and wine storage bin 216a, and tracking system 500 and tracker App 102 receive a video/image from detector 504. In decision step 608, tracking system 500 and tracker App 102 analyze the received video/image and compare it against stored information pertaining to the desired location to determine whether the location of the targeting beam is correct. Such comparison information can include a previously stored image of the storage bin 216a, and/or information contained in wine DB record 104 according to aspects of the embodiments. In decision step 608, if the correct position has not been found (“No” path from decision step 610), method 600 returns to method step 604 and tracking system 500 and tracker App 102 transmit one or more commands to transmitter 502 to move transmitted light beam 506 in a certain direction, based on the results of the analysis in decision step 608. If the beam is at the correct location (“Yes” path from decision step 608), method 600 either terminates or proceeds to method step 610, in which additional analysis can be performed and/or other information from wine DB record 104 obtained and provided to the user.

Aspects of the embodiments relate to using an automated tracking system (tracking systems 100, 500) to look up and point to the location of an existing/stored wine bottle 218a in wine storage are 214. According to aspects of the embodiments, the location of wine bottle 218 is marked and shown on a display of the user interface (UI) of tacking systems 100,500. The storage location can be marked on the view/image of wine storage area 214 where wine bottle 218 is located. According to aspects of the embodiments, the user interface can be an application running on a mobile phone, and/or a laptop, and/or a tablet, and/or other computing device with a display.

According to aspects of the embodiments, the location of wine bottle 218 can be shown as an augmented reality (AR) type of display on the display of the user interface of tracking systems 100,500. According to aspects of the embodiments, the user interface can be a mobile/AR enabled device. According to aspects of the embodiments, the user interface (UI) is an application running on a device wherein the device comprises one or more of a mobile phone, and/or a laptop, and/or a tablet, and/or other computing device with a display. According to aspects of the embodiments, the location can be marked with a marker (e.g., an icon, image, among other types of markers) on a view/image of wine storage area 214 where wine bottle 218 is located. The marker location on the view/image can be updated as the user interface device moves, and its camera provides new views/images of wine storage area 214. By way of one non-limiting example, the AR device according to aspects of the embodiments can be a mobile phone, and the user can hold the mobile phone in front of wine storage area 214. The device camera can capture an image of wine storage area 214 and the user interface can display that image/view of wine storage area 214 with the location of wine bottle 218 marked. As the user moves or brings the mobile phone closer to wine storage area 214, the image/view of the marked location can be updated, displaying wine bottle 218a location to the user. According to aspects of the embodiments, the user can tap on any other wine locations displayed/viewed on the screen and tracking systems 100,500 can show the content of wine DB record 104 corresponding to the particular wine bottle 218a that is stored in wine storage bin 216a in either or both of tracking systems 100,500—that is, the wine information for wine bottle 218a stored in that location (wine storage bin 216a) is shown on the screen of the device.

According to aspects of the embodiments, tracking systems 100,500 first identify which panel/scene the mobile/AR enabled device is pointing to by comparing the images/video signals from the mobile/AR enabled device and the images/video signals from cameras 202,502,504. According to aspects of the embodiments, certain image features (similar to the ones used for label recognition) can be used to find the best match between the images/video signals from the mobile/AR enabled device and the images/video signals from cameras 202,502,504. According to aspects of the embodiments, the two scenes can be aligned by estimating the “homography” matrix transformation. The homography matrix is a linear transformation that converts the image/scene captured from tracking systems 100,500 camera point-of-view (the matched scene) to the image/scene seen from the mobile/AR enabled device. According to aspects of the embodiments, tracking systems 100,500 can map the locations and Bottle Locations IDs between the two images using this homography matrix, retrieve the required information from one or more wine DB record 104, and displays the information to the user of tracking systems 100,500 on the mobile/AR device or other user interface display.

According to aspects of the embodiments, tracking system 500 can use optical pointing/beaming to indicate/illuminate the location of an object in a stored location, such as wine bottle 218 in wine storage area 214, or a wine cellar. As those of skill in the art can appreciate, such object localization has been traditionally accomplished by physically tagging or labeling the location. The tag or label is printed and placed on the storage or inventory area at or close to the stored objects. A record of the tags and items are generated and used when searching or attempting to locate a stored item or object. According to aspects of the embodiments, the location of wine bottles 218 can be tagged by electronic tags or light indicators (such as one or more light emitting diodes (LEDs)), and such electronic tags can be connected to tracking systems 100,500 that can activate them when searching for a specific wine bottle 218a.

According to further aspects of the embodiments, one or more particular implementations of tracking systems 100,500 exists wherein usage of a tag or label is not desired. That is, placements of tags and labels can be costly and time consuming, and a labor-intensive task. Thus, according to further aspects of the embodiments, use of an automatic optical pointing/beaming system, such as tracking systems 100,500 can be used wherein the system will substantially automatically indicate/illuminate the desired location of a given object/item, such as wine bottle 218a, upon receiving information related to location of wine bottle 218a, such as its Bottle Location ID or other information stored in wine DB record 104a. According to further aspects of the embodiments, a further implementation of tracking systems 100,500 can be to determine whether one or more bins 216 are empty or not, i.e., an inventory management functions. Such inventory “sweeps” can occur periodically, such as the end of the business day, or some other periodic or random period of time to assist in ordering new stock as needed, among other uses.

FIG. 7 illustrates a simplified diagram of wine DB record 104 that contains a plurality of fields 702a-q for storing relevant wine information for use with the systems and methods of FIGS. 1-6 according to aspects of the embodiments. Since wine DB record 104 has already been discussed in detail above, in fulfillment of the dual purposes of clarity and brevity, further discussion of the same has been omitted.

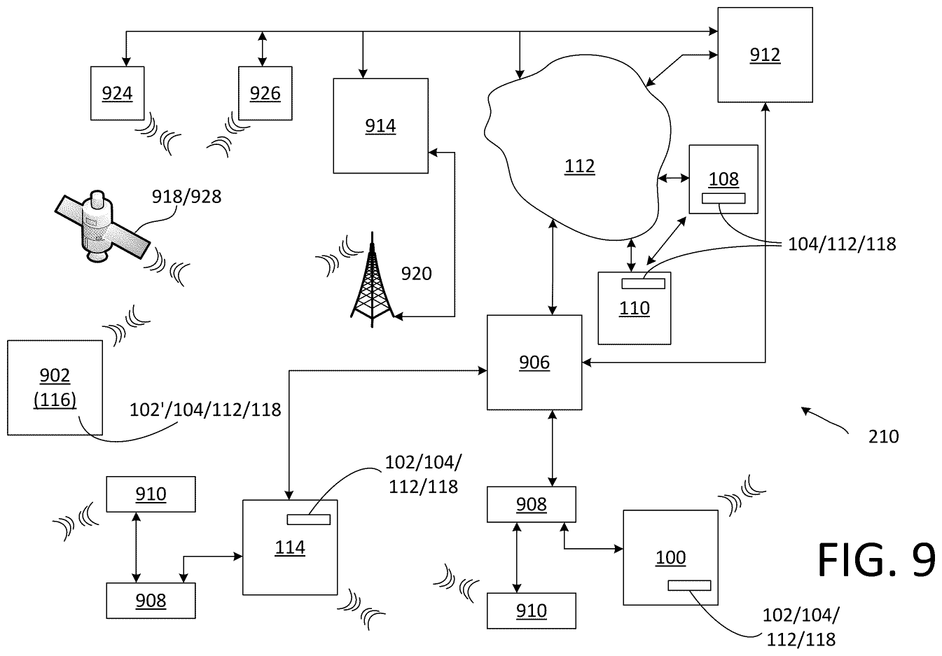

According to aspects of the embodiments, a smaller version of tracker App 102 that provides for a wine cellar management solution can be implemented on a mobile phone or personal electronic device (for the purposes of this discussion, modified tracker App 102′ will be discussed only in the context of a mobile device, which has been discussed in regard to FIG. 9 as a personal electronic device (PED) 902). Modified tracker App 102′ used images taken by the camera of the mobile device after changes have been made to an inventory in wine storage area 214. Modified tracker App 102′ can be used with smaller wine cellars where a complete solution with multiple cameras is unnecessary and the size of the wine cellar does not justify the complexity and/or the installation costs.

Use of modified tracker App 102′ and mobile device 116 begins with the user photographing an empty or substantially empty wine storage area 214 in its entirety using the camera of mobile device 116 within use of modified tracker App 102′. That is, a portion of modified tracker App 102′ contains a user interface for taking photographs of wine storage area 214. According to further aspects of the embodiments, one or more panoramic photograph views can also be used. According to further aspects of the embodiments, modified tracker App 102′ can also stitch together multiple images of wine storage area 214 using currently available image processing techniques to create a panoramic image of wine storage area 214. These initial photos can be referred to as “reference images” and can be used by modified tracker App 102′ to identify different locations in wine storage area 214.

As a new wine bottle 218a is added to wine storage area 214, the user first accesses modified tracker App 102′ and then takes a photograph of the label of the new wine bottle 218a; more than one photo can be taken and stored. This photo provides for the generation of the Wine Info ID for the particular wine bottle 218a by modified tracker App 102′. A new wine DB record 104a is also generated and the Wine Info ID is added to it. Extracting the Wine Info ID from the label scan and generation of wine DB record 104 is substantially similar to that as previously described above.

Following taking photographs of the new wine bottle 218a, the user proceeds to place/store new wine bottle 218 in its own bin 216a in wine storage area 214 and takes a photograph of that location/panel after placement of new wine bottle 218a, using modified tracker App 102′.

Following the capturing of images of the new wine bottle 218a in its new storage location, bin 216a, modified tracker App 102′ uses the image of the bottle as stored (e.g., the “new image” (or “image_1”)) versus that of previously taken photos of the empty or substantially empty wine storage area 214 (referred to as a “reference image” (or “image_0”)). According to further aspects of the embodiments, modified tracker App 102′ can also compare the newly taken photograph (new image) with additional previously captured images of wine storage area (reference image) when previous wine bottles 218 had been stored using modified tracker App 102′, in order to provide greater accuracy in learning the location/panel where the new wine bottle 218 has been stored. Such comparisons and learning can be accomplished using one or more of a plurality of computer vision techniques. By way of non-limiting example, some image features can be extracted from the most recent image and the reference images to find the best match (using SIFT, SURF or ORB features are among the features that can be used). According to further aspects of the embodiments, substantially similar techniques as described above for image processing and computer vision techniques can be used with modified tracker App 102′. According to still further aspects of the embodiments, panels and locations can be marked by indicators (for example barcodes that can be read and decoded from the images, or numbers that can be recognized by applying computer vision models) to learn and verify the storage location (bin 216a) of the new wine bottle 218a. The indicators in the most recent image and the reference images can be matched to identify the location where the user has added the new wine bottle 218a. Modified tracker App 102′ can also analyze more recent images and compare the objects in the most recent image with the ones taken previously to identify the location where the new wine bottle 218a has been added; as those of skill in the art can appreciate, time stamps can be added to all photographs to ensure proper documentation and use with modified tracker App 102′. According to still further aspects of the embodiments, a local positioning system can be used, that is one built from WiFi/Near Field Communications/Bluetooth devices to map the storage locations within storage area 214. Modified tracker App 102′ then associates the location of the new wine bottle 218a (in the reference image) with the extracted Wine Info ID and adds it to wine DB record 104a and the inventory.

In a substantially similar process, when a user removes a wine bottle 218 from wine storage area 214, the user can take a photo of the now empty storage location 216a using the camera of mobile device 116 and modified tracker App 102′. In addition, the user can also take a photo of the label of the removed wine bottle 218a such that Modified tracker App 102′ can correlate the now empty storage location 216a with the wine bottle 218a that has been removed, and updates the inventory and corresponding wine DB record 104a.

According to further aspects of the embodiments, the systems and methods described herein, and as shown in regard to the Figures as well, can incorporate additional features and functions, described below, and which are related to inventory management, optimized consumption, security protection, active inventory valuation, understanding customer's tastes and predicting what type of wines the customer might want, providing suggested food pairings based on either or both of purchased wines and suggested wines, and information management using “Big Data” and “Internet of Things” (IoT) methods and systems (which can also be referred to as data analytics (“Data analysis is a process of inspecting, cleansing, transforming and modeling data with the goal of discovering useful information, informing conclusion and supporting decision-making”), among other features and functions.

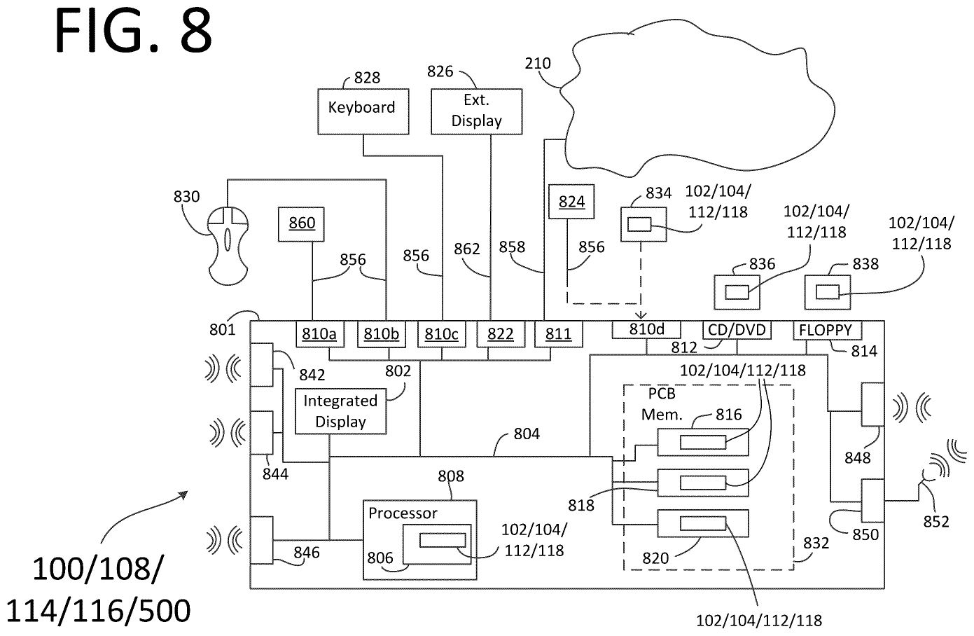

FIG. 8 illustrates a block diagram of the major components of a computer device, personal computer, server, laptop, and/or personal electronic device (herein after, “computer device”) suitable for use to implement the methods shown in regard to FIGS. 3, 4, and 6, among others, for tracking wine bottles in a wine bottle storage area on a computer device using the wine bottle tracking software applications according to aspects of the embodiments.

FIG. 8 illustrates a block diagram of the major components of a computer device, PC, server, laptop, and/or Devices 100, 108. 102, 108, 112, and mobile device 116 (herein after, “computer device”) suitable for use to implement methods 300, 400, and 600 among others, for wine bottle inventory and storage management according to aspects of the embodiments. The computer device comprises, among other items, shell/box 801, integrated display/touch-screen 802 (though not used in every application of the computer device), internal data/command bus (bus) 804, processor board/PC internal memory (internal memory) 832, and one or more processors 808 with processor internal memory 806 (which can be typically read only memory (ROM) and/or random access memory (RAM)). Those of ordinary skill in the art can appreciate that in modern computer device systems, parallel processing is becoming increasingly prevalent, and whereas a single processor would have been used in the past to implement many or at least several functions, it is more common currently to have a single dedicated processor for certain functions (e.g., digital signal processors) and therefore could be several processors, acting in serial and/or parallel, as required by the specific application. The computer device further comprises multiple input/output ports, such as universal serial bus (USB) ports 810, Ethernet ports 811, and video graphics array (VGA) ports/high definition multimedia interface (HDMI) ports 822, among other types. Further, the computer device includes externally accessible drives such as compact disk (CD)/digital versatile disk (DVD) read/write (RW) (CD/DVD/RW) drive 812, and floppy diskette drive 814 (though less used currently, some computer devices still include this type of interface). The computer device still further includes wireless communication apparatus, such as one or more of the following: Wi-Fi transceiver 842, BlueTooth (BT) transceiver 844, near field communications (NFC) transceiver 846, third generation (3G)/fourth Generation (4G)/long term evolution (LTE)/fifth generation (5G) transceiver (cellular transceiver) 848, communications satellite/global positioning system (satellite) transceiver 850, and antenna 852.

Internal memory 832 itself can comprise hard disk drive (HDD) 816 (these can include conventional magnetic storage media, but, as is becoming increasingly more prevalent, can include flash drive memory 834, among other types), ROM 818 (these can include electrically erasable programmable ROM (EEPROMs), ultra-violet erasable PROMs (UVPROMs), among other types), and RAM 820. Usable USB port 810 is flash drive memory 834, and usable with CD/DVD/RW drive 812 are CD/DVD diskettes (CD/DVD) 836 (which can be both read and write-able). Usable with floppy diskette drive 814 are floppy diskettes 838. External memory storage device 824 can be used to store data and programs external to box 801 of the computer device, and can itself comprise another hard disk drive 816a, flash drive memory 834, among other types of memory storage. External memory storage device 824 is connectable to the computer device via USB cable 856. Each of the memory storage devices, or the memory storage media (806, 816, 818, 820, 824, 834, 836, and 838, among others), can contain parts or components, or in its entirety, executable software programming code or application that has been termed tracker App 102 (or modified tracker App 102′) and wine Info App 112 according to aspects of the embodiments, which can implement part or all of the portions of methods 300, 400, and 600, among other methods not shown, described herein. In addition, each of the memory storage devices, or the memory storage media (806, 816, 818, 820, 824, 834, 836, and 838, among others), can contain parts or components, or in its entirety, executable software programming code or application that has been termed wine DB record 104 and wine information database 118 according to aspects of the embodiments.

In addition to the above described components, the computer device also comprises keyboard 828, external display 826, printer/scanner/fax machine 860, and mouse 830 (although not technically part of the computer device, the peripheral components as shown in FIGS. 8 (824, 826, 828, 830, 834, 836, 838, 856, 858, 860, and 862) are adapted for use with the computer device that for purposes of this discussion they shall be considered as being part of the computer device). Other cable types that can be used with the computer device include RS 232, among others, not shown, that can be used for one or more of the connections between the computer device and the peripheral components described herein. Keyboard 828, and mouse 830 are connectable to the computer device via USB cable 56, and external display 826 is connectible to the computer device via VGA cable/HDMI cable 862. The computer device is connectible to network 106 via Ethernet port 811 and Ethernet cable 858 via a router and modulator-demodulator (MODEM) and internet service provider, none of which are shown in FIG. 8. All of the immediately aforementioned components (822, 824, 826, 828, 830, 834, 836, 838, 856, 858, and 860) are known to those of ordinary skill in the art, and this description includes all known and future variants of these types of devices.

External display 826 can be any type of currently available display or presentation screen, such as liquid crystal displays (LCDs), light emitting diode displays (LEDs), plasma displays, cathode ray tubes (CRTs), among others (including touch screen displays). In addition to the user interface mechanism such as mouse 830, the computer device can further include a microphone, touch pad, joy stick, touch screen, voice-recognition system, among other inter-active inter-communicative devices/programs, which can be used to enter data and voice, and which all of are currently available and thus a detailed discussion thereof has been omitted in fulfillment of the dual purposes of clarity and brevity.

As mentioned above, the computer device further comprises a plurality of wireless transceiver devices, such as Wi-Fi transceiver 842, BT transceiver 844, NFC transceiver 846, cellular transceiver 848, satellite transceiver 850, and antenna 852. While each of Wi-Fi transceiver 842, BT transceiver 844, NFC transceiver 846, cellular transceiver 848, and satellite transceiver 850 has their own specialized functions, each can also be used for other types of communications, such as accessing a cellular service provider (not shown), accessing network 106 (which can include the Internet), texting, emailing, among other types communications and data/voice transfers/exchanges, as known to those of skill in the art. Each of Wi-Fi transceiver 842, BT transceiver 844, NFC transceiver 846, cellular transceiver 848, satellite transceiver 850 includes a transmitting and receiving device, and a specialized antenna, although in some instances, one antenna can be shared by one or more of Wi-Fi transceiver 842, BT transceiver 844, NFC transceiver 846, cellular transceiver 848, and satellite transceiver 850. Alternatively, one or more of Wi-Fi transceiver 842, BT transceiver 844, NFC transceiver 846, cellular transceiver 848, and satellite transceiver 850 will have a specialized antenna, such as satellite transceiver 850 to which is electrically connected at least one antenna 852.

In addition, the computer device can access network 106 (which can be the Internet), either through a hard wired connection such as Ethernet port 811 as described above, or wirelessly via Wi-Fi transceiver 842, cellular transceiver 848 and/or satellite transceiver 850 (and their respective antennas) according to aspects of the embodiments. The computer device can also be part of a larger network configuration as in a global area network (GAN) (e.g., internet), which ultimately allows connection to various landlines.

According to further aspects of the embodiments, integrated touch screen display 802, keyboard 828, mouse 830, and external display 826 (if in the form of a touch screen), can provide a means for a user to enter commands, data, digital, and analog information into the computer device. Integrated and external displays 802, 826 can be used to show visual representations of acquired data, and the status of applications that can be running, among other things.

Bus 804 provides a data/command pathway for items such as: the transfer and storage of data/commands between processor 808, Wi-Fi transceiver 842, BT transceiver 844, NFC transceiver 846, cellular transceiver 848, satellite transceiver 850, integrated display 802, USB port 810, Ethernet port 811, VGA/HDMI port 822, CD/DVD/RW drive 812, floppy diskette drive 814, and internal memory 832. Through bus 804, data can be accessed that is stored in internal memory 832. Processor 808 can send information for visual display to either or both of integrated and external displays 802, 826, and the user can send commands to the system operating tracker App 102 and/or wine Info App 112 hat might reside in processor internal memory 806 of processor 808, or any of the other memory devices (836, 838, 816, 818, and 820).

The computer device, and either processor internal memory 806 or internal memory 832, can be used to implement one or more, or any combination thereof, methods 1400, 1500, and 1600, as well as those not shown and discussed, for managing and inventory control of wine storage areas using a computer device according to aspects of the embodiments. Hardware, firmware, software, or a combination thereof can be used to perform the various steps and operations described herein. According to aspects of the embodiments, tracker App 102 and/or wine Info App 112 for carrying out the above discussed steps can be stored and distributed on multi-media storage devices such as devices 816, 818, 820, 834, 836 and/or 838 (described above) or other form of media capable of portably storing information. Storage media 834, 836 and/or 838 can be inserted into, and read by devices such as USB port 810, CD/DVD/RW drive 812, and floppy disk drive 814, respectively.

As also will be appreciated by one skilled in the art, the various functional aspects of the aspects of the embodiments can be embodied in a wireless communication device, a telecommunication network, or as a method or in a computer program product. Accordingly, aspects of embodiments can take the form of an entirely hardware embodiment or an embodiment combining hardware and software aspects. Further, the aspects of embodiments can take the form of a computer program product stored on a computer-readable storage medium having computer-readable instructions embodied in the medium. Any suitable computer-readable medium can be utilized, including hard disks, CD-ROMs, DVDs, optical storage devices, or magnetic storage devices such a floppy disk or magnetic tape. Other non-limiting examples of computer-readable media include flash-type memories or other known types of memories.

Further, those of ordinary skill in the art in the field of the aspects of the embodiments can appreciate that such functionality can be designed into various types of circuitry, including, but not limited to field programmable gate array structures (FPGAs), application specific integrated circuitry (ASICs), microprocessor based systems, among other types. A detailed discussion of the various types of physical circuit implementations does not substantively aid in an understanding of the aspects of the embodiments, and as such has been omitted for the dual purposes of brevity and clarity. However, the systems and methods discussed herein can be implemented as discussed and can further include programmable devices.

Such programmable devices and/or other types of circuitry as previously discussed can include a processing unit, a system memory, and a system bus that couples various system components including the system memory to the processing unit. The system bus can be any of several types of bus structures including a memory bus or memory controller, a peripheral bus, and a local bus using any of a variety of bus architectures. Furthermore, various types of computer readable media can be used to store programmable instructions. Computer readable media can be any available media that can be accessed by the processing unit. By way of example, and not limitation, computer readable media can comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CD-ROMs, DVDs or other optical disk storage, magnetic cassettes, magnetic tape, magnetic disk storage or other magnetic storage devices, or any other medium which can be used to store the desired information and which can be accessed by the processing unit. Communication media can embody computer readable instructions, data structures, program modules or other data in a modulated data signal such as a carrier wave or other transport mechanism and can include any suitable information delivery media.

The system memory can include computer storage media in the form of volatile and/or nonvolatile memory such as ROM and/or RAM. A basic input/output system (BIOS), containing the basic routines that help to transfer information between elements connected to and between the processor, such as during start-up, can be stored in memory. The memory can also contain data and/or program modules that are immediately accessible to and/or presently being operated on by the processing unit. By way of non-limiting example, the memory can also include an operating system, application programs, other program modules, and program data.

The processor can also include other removable/non-removable and volatile/nonvolatile computer storage media. For example, the processor can access a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the operating environment include, but are not limited to, magnetic tape cassettes, flash memory cards, digital versatile disks, digital video tape, solid state RAM, solid state ROM and the like. A hard disk drive can be connected to the system bus through a non-removable memory interface such as an interface, and a magnetic disk drive or optical disk drive can be connected to the system bus by a removable memory interface, such as an interface.

Aspects of the embodiments discussed herein can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include ROM, RAM, CD-ROMs and generally optical data storage devices, magnetic tapes, flash drives, and floppy disks. The computer-readable recording medium can also be distributed over network coupled computer systems so that the computer-readable code is stored and executed in a distributed fashion. The computer-readable transmission medium can transmit carrier waves or signals (e.g., wired, or wireless data transmission through the Internet). Also, functional programs, codes, and code segments to, when implemented in suitable electronic hardware, accomplish or support exercising certain elements of the appended claims can be readily construed by programmers skilled in the art to which the aspects of the embodiments pertains.

The disclosed aspects of the embodiments provide a system and method for wine bottle storage and inventory management control on one or more computer devices. It should be understood that this description is not intended to limit aspects of the embodiments. On the contrary, aspects of the embodiments are intended to cover alternatives, modifications, and equivalents, which are included in the spirit and scope of the aspects of the embodiments as defined by the appended claims. Further, in the detailed description of the aspects of the embodiments, numerous specific details are set forth to provide a comprehensive understanding of the claimed aspects of the embodiments. However, one skilled in the art would understand that various aspects of the embodiments can be practiced without such specific details.

FIG. 9 illustrates network system 210 within which the system and method for wine bottle storage and inventory management control on a computer device can be implemented according to aspects of the embodiments. Much of the infrastructure of network system 210 shown in FIG. 9 is or should be known to those of skill in the art, so, in fulfillment of the dual purposes of clarity and brevity, a detailed discussion thereof shall be omitted.

According to aspects of the embodiments, a user of the above described system and method can store tracker App 102, modified tracker App 102′, wine Info App 112, and/or wine information database 118 on their PED 902, mobile device 116, as well as devices 100, 112 and 500. Mobile devices 116, or personal electronic device (PEDs) 902 can include, but are not limited to, so-called smart phones, tablets, personal digital assistants (PDAs), notebook and laptop computers, and essentially any device that can access the internet and/or cellular phone service or can facilitate transfer of the same type of data in either a wired or wireless manner

PED 102 can access cellular service provider 914, either through a wireless connection (cellular tower 920) or via a wireless/wired interconnection (a “Wi-Fi” system that comprises, e.g., modulator/demodulator (modem) 908, wireless router 910, internet service provider (ISP) 906, and internet 922). Further, PED 102 can include NFC, “Wi-Fi,” and Bluetooth (BT) communications capabilities as well, all of which are known to those of skill in the art. To that end, network system 106 further includes, as many homes (and businesses) do, one or more PEDs 102 that can be connected to wireless router 910 via a wired connection (e.g., modem 908) or via a wireless connection (e.g., Bluetooth). Modem 908 can be connected to ISP 906 to provide internet-based communications in the appropriate format to end users (e.g., PED 102), and which takes signals from the end users and forwards them to ISP 906.

PEDs 102 can also access global positioning system (GPS) satellite 928, which is controlled by GPS station 924, to obtain positioning information (which can be useful for different aspects of the embodiments), or PEDs 102 can obtain positioning information via cellular service provider 914 using cellular 922 tower(s) 920 according to one or more methods of position determination. Some PEDs 902 can also access communication satellites 918 and their respective satellite communication systems control stations 926 (the satellite in FIG. 9 is shown common to both communications and GPS functions) for near-universal communications capabilities, albeit at a much higher cost than convention “terrestrial” cellular services. PED 902 can also obtain positioning information when near or internal to a building (or arena/stadium) through the use of one or more of NFC/BT devices. FIG. 9 also illustrates other components of network 106 such as plain old telephone service (POTS) provider 912.

According to further aspects of the embodiments, and as described above, network 210 also contains servers/devices 100, 112, 500 that can include tracker App 102 and/or wine Info App 112, wherein one or more processors, using currently available technology, such as memory, data and instruction buses, and other electronic devices, can store and implement code that can implement the system and method for wine bottle inventory and management control on a computer device according to aspects of the embodiments.

According to further aspects of the embodiments, additional features and functions of inventive embodiments are described herein below, wherein such descriptions are to be viewed in light of the above noted detailed embodiments as understood by those skilled in the art.

According to further aspects of the embodiments, there are several inventory management features and functions that can be implemented utilizing one or more of tracking system 100, tracker App 102, wine DB record 104, wine DB server 110, and wine Inf. App 112 among the other elements and features shown and described in regard to FIGS. 1-6. The several inventory management features and functions include a voice-enabled/assisted user interface (UI), an auto inventory reorder feature, an inbound asset management feature, and an active inventory valuation, among other features and functions related to inventory management. Each of these are described below in turn.

According to aspects of the embodiments, the voice-enabled/assisted UI can implement an Amazon®-Alexa® like voice assist for the user interface. That is, using one or more of tracking system 100, tracker App 102, wine DB record 104, wine DB server 110, and wine Inf. App 112 among the other elements and features shown and described in regard to FIGS. 1-6 a user can approach a wine storage area 214 and describe in their own words, using their own voice, what type of wine or wines they are looking for; such a query does not have to be specific to a type of wine or year, or described with any specificity at all, but can begin with nothing more than a simple request such as “I'd like to get a bottle of wine,” and then prompts and questions can be responded to by the user to determine the most appropriate wine choice based on the user's responses. In addition to providing one or more recommendations, the plurality of components of wine tracking system 100 can also include directions/instruction as to how to find the one or more recommended bottles of wine in the wine cellar/storage location 214, and/or order the one or more recommended bottles of wine.

According to aspects of the embodiments, the auto inventory reorder feature can provide low inventory notifications, and suggestions of similar wines according to the owner's/collector's taste and preferences and reordering low inventory contents according to these preferences.

According to aspects of the embodiments, the inbound asset management feature can manage and track new wine orders. Aspects of the embodiments can provide a means to the owner to share new wine orders with the system. For example, the owner can forward the email confirmations for new orders to an email address registered to tracking system 100. Tracking system 100 can analyze the invoices and add the ordered bottles to the inventory with “Pending” status, remind the user/owner on the delivery dates and follow up on the pending bottles until they are added to the inventory.

According to aspects of the embodiments, the active inventory valuation feature can provide inventory value estimation and projections (based on price historical trends and projections). According to aspects of the embodiments, the active inventory valuation feature actively provides the current value of the inventory (value of all wines stored) using the current/updated market price for the wine bottles in the inventory (note that some wines in the inventory may have been purchased many years ago and may have appreciated significantly, or the purchase price may not be available for them; so having access to the current market value may be of importance to these embodiments). According to aspects of the embodiments, the active inventory valuation feature also provides projections on the value of some bottles of interest (for example, high value/fine/collectible wines) to the customer/wine collector. In certain embodiments, the collector may not have those wines in his/her inventory and may be thinking of investing in them. According to aspects of the embodiments, the active inventory valuation feature deploys machine learning (ML), time-series analysis, and forecasting techniques, among other price determining techniques, to project the price for those bottles of interest and estimate return-on-investment (RoI) that enables the customer to make a wise investment decision.

According to aspects of the embodiments, the active inventory valuation feature the solution compiles a set of historical prices (prices over a span of time since production/introduction of the wine) for a large set of high-value and collectible fine wines (e.g., known to wine experts). For example, the company LIV-EX (https://www.liv-ex.com) gathers large amounts of fine wine prices (from trading and transactions, auctions). According to aspects of the embodiments, the historical prices may not be available for all wine types of interest (lack of historical records), or a wine may be produced fairly recently, and the history of the prices may not be extensive/rich. In certain embodiments, this data is fed to one or more ML algorithms together with other information, characteristics and features of each wine type including but not limited to wine brand, varietal, vintage, vinery, vineyard, region, taste characteristics, customer and critic comments and reviews and any indication if the wine is limited production.

In certain embodiments, the price of a particular wine is projected in the future, based on historical prices of the same wine, or similar wines. Time-series and forecasting techniques are used in certain embodiments to project the price of a particular bottle of wine based on its own historical data. Moreover, in certain embodiments, ML techniques (e.g., unsupervised learning and clustering algorithms like K-means) are used to find similar wines (to the wine of interest) using the features and characteristics provided for each wine type. In certain embodiments, the system can then use the historical prices and trends for those “similar” wines to project the price of the wine of interest (e.g., for which, the historical price data may not be available, or may be limited).

According to further aspects of the embodiments, there are several optimized consumption features and functions that can be implemented utilizing one or more of tracking system 100, tracker App 102, wine DB record 104, wine DB server 110, and wine Inf. App 112 among the other elements and features shown and described in regard to FIGS. 1-6. The several optimized consumption features and functions include integrated critic review/recommendations, best time to consume information, recommendations on food-wine pairing, and updates from wineries/producers on new products, among other features and functions related to optimized consumption. Each of these are described below in turn.

According to aspects of the embodiments, the recommendation on wine and food pairings feature can provide information on wine for different occasions and seasonal wine suggestions.

According to aspects of the embodiments, understanding the customer's taste and what he/she might like is the basis of providing various recommendations for different use cases. For example, in an Auto inventory reorder feature embodiment, the solution suggests and/or orders similar wines (e.g., similar to the ones running out in the inventory) that the customer will most probably like. Various ML techniques including collaborative filtering are used in certain embodiments to predict the customer's rating/interest level for a particular wine type (i.e., that he has never tried) based on his/her feedback on similar wines. For example, in a certain embodiment, the solution asks/requests the customer for his/her feedback for consumed wines over time (e.g., a simple one is how the customer likes the taste on a 1-5 scale; more detailed questions on the taste characteristics are compiled in related embodiments). Or the solution analyzes, in certain embodiments, the consumption or acquisition of wines over time and based on that predicts what the customer would like with high probabilities (e.g., if he/she consumes a certain wine type 3 times more than others, then he/should most probably like that wine type more than others). As described above in certain pricing projection embodiments, wines that are similar in taste/characteristics are identified and grouped together based on various wine features, though these features are non-limiting. As pointed out above, various ML techniques are used in such embodiments. Then the solution predicts, in related embodiments, such features as the customer's rating for a particular wine type based on the customer's feedback on similar wines (e.g., one algorithm used for this in the embodiments is called collaborative filtering). This is the basis for many recommendation systems of the present embodiments. Certain similar systems to those of these embodiments are widely used for example in Amazon® and/or Netflix®, where the system predicts the customer's rating of a movie based on his/her previous ratings and the ratings of other customers. In these embodiments, the same and similar idea is applied to wine and the foregoing embodiments.

According to aspects of the embodiments, these predictions are used in one or more of the features listed above to offer the customer a customized/tailored service.

Two non-limiting examples of such cases provided in the embodiments are summarized as the following:

For Auto inventory reorder feature, the solution of the embodiments can suggest and/or order similar wines that the customer would like.

When recommending wines for investment, the solution in certain embodiments recommends wines that have, as one example, high RoI and that the customer is most likely to enjoy it.

According to aspects of the embodiments, big data analytics plays an important role in the features and functions of these embodiment, as well. For example, for seasonal suggestions, in certain embodiments, the solution analyzes the consumption of, for example, all (or a subset of) the users (e.g., the users of the cellar management solution) that are presumably living in similar climates, and based on dominant consumption of certain wine types/brands, geography, nation of origin of the user(s), socio-economic indicators, and the like, aspects of the embodiments provide one or more recommendations. Exemplary and non-limiting recommendations include, for example, that a particular wine has a certain popularity in a given region in a certain time of the year.

According to aspects of the embodiments, the updates from wineries and producers on new products feature can provide information on wines that match the owner's taste and preference.

According to further aspects of the embodiments, there are several security protection features and functions that can be implemented utilizing one or more of tracking system 100, tracker App 102, wine DB record 104, wine DB server 110, and wine Inf. App 112 among the other elements and features shown and described in regard to FIGS. 1-6. The several security protection features and functions include security surveillance, active temperature monitoring and alerts, and alarms to protect high-value assets. Each of these are described below in turn.

According to aspects of the embodiments, the security surveillance feature can include cameras (video, still, infrared, among other types), that can operate as security cameras. Such security cameras can incorporate software that performs facial recognition, among other security features.

According to aspects of the embodiments, the active temperature monitoring and alert feature can include the use of infra-red cameras, remotely located digital thermometers and the like, humidity sensors, light sensors, and the like, among other environmental-related monitoring features.

According to aspects of the embodiments, the high value asset alarm feature can include the tracking of specific, relatively expensive bottles of wine (specially tagged bottles), such that alarms can be generated should any one of these specially tagged bottles be moved. Once such movement occurs, security features can ascertain that the moving individual is authorized to move the bottle, as an owner, purchaser, or some other specially designated class of authorized individuals.

According to further aspects of the embodiments, additional features and functions of inventive embodiments are described herein below, wherein such descriptions are to be viewed in light of the above noted detailed embodiments as understood by those skilled in the art.

According to further aspects of the embodiments, system 100 and the various embodiments as described in FIGS. 1-9 can be implemented in previously designed and fabricated wine storage areas such as retail establishments, or home owners' wine cellars, or can be implemented as part of an original, new design as generated by one or more architects, and built by one or more builders, contractors, and the like. That is, according to further aspects of the embodiments, one or more architects can generate a new design of a wine storage area, whether as a retail, wholesale, warehouse enterprise location, and which can be built by one or more of a builder, contractor, construction company, and the like. Further still, according to further aspects of the embodiments, one or more architects can generate a new design of a wine storage area, in a private home (i.e., private wine storage cellar), club setting (e.g., a country club, or other private/semi-private enterprise location) and the like, and which can be built by one or more of a builder, contractor, construction company, and the like. That is, according to further aspects of the embodiments, one or more of an architect and builder can design, install, or be responsible for designing and/or installing systems 100, 500 (as shown in FIGS. 1, 2, and 5) that implement one or more of methods 300, 400, and 600 (as shown in FIGS. 3, 4, and 6).

According to further aspects of the embodiments, and as described herein, above, a prodigious amount of information can be collected by the systems and methods described herein. Such information can be public and concerns items such as wines, and their manufacture, business entities, but also a great deal of information can concern people. In the former case, such vast amounts of information can be processed and handled by systems that can be referred to as the Internet of Things (IoT), i.e., large amounts of data that is stored, analyzed, and used through use of the Internet. In the latter case, the privacy of individuals is of utmost importance. Many states within the U.S., and other countries or political entities such as the European Union, have very strict privacy laws about what can and cannot be collected, retained, and disseminated. According to an aspect of the embodiment, whatever personal information may be collected by the systems and methods described herein is only stored locally and never transmitted through the Internet or any other network except for a local network to a locally located server. In addition, such personal information is only stored for such duration as is necessary to conduct the business affairs of the entity that is providing the service of storing and/or selling the wine. According to further aspects of the embodiments, whatever personal information that might be collected by the systems and methods described herein can be transmitted via the Internet or other networks as long as express permission is granted by the individual, and only for a minimum duration as is necessary to conduct the business affairs of the entity that is providing the service of storing and/or selling the wine.

According to further aspects of the embodiments, additional features and functions of inventive embodiments are described herein below, wherein such descriptions are to be viewed in light of the above noted detailed embodiments as understood by those skilled in the art.

As described above, an encoding process is discussed specifically in reference to FIGS. 3, 4, and 6, although such delineation is not meant to be, and should not be taken in a limiting manner, as additional methods according to aspects of the embodiments have been described herein. The encoding processes as described are not meant to limit the aspects of the embodiments, or to suggest that the aspects of the embodiments should be implemented following the encoding processes. The purpose of the encoding processes as described is to facilitate the understanding of one or more aspects of the embodiments and to provide the reader with one or many possible implementations of the processed discussed herein. FIGS. 14-16 illustrates a flowchart of various steps performed during the encoding process, but such encoding processes are not limited thereto. The steps of FIGS. 14-16 are not intended to completely describe the encoding processes but only to illustrate some of the aspects discussed above.

This application may contain material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

The disclosed embodiments provide a system, software, and a method for wine bottle management and inventory control on a computer device. It should be understood that this description is not intended to limit the embodiments. On the contrary, the embodiments are intended to cover alternatives, modifications, and equivalents, which are included in the spirit and scope of the embodiments as defined by the appended claims. Further, in the detailed description of the embodiments, numerous specific details are set forth to provide a comprehensive understanding of the claimed embodiments. However, one skilled in the art would understand that various embodiments may be practiced without such specific details.

Although the features and elements of aspects of the embodiments are described being in particular combinations, each feature or element can be used alone, without the other features and elements of the embodiments, or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

The above-described embodiments are intended to be illustrative in all respects, rather than restrictive, of the embodiments. Thus, the embodiments are capable of many variations in detailed implementation that can be derived from the description contained herein by a person skilled in the art. No element, act, or instruction used in the description of the present application should be construed as critical or essential to the embodiments unless explicitly described as such. Also, as used herein, the article “a” is intended to include one or more items.

All United States patents and applications, foreign patents, and publications discussed above are hereby incorporated herein by reference in their entireties.

### INDUSTRIAL APPLICABILITY

To solve the aforementioned problems, the aspects of the embodiments are directed towards systems, methods, and modes for a computer-based dynamic content generation application that facilitates document creation through the substantially seamless synthesis of information from multiple reference files and file types to edit text/content within one integrated space.

### Alternate Embodiments

Alternate embodiments may be devised without departing from the spirit or the scope of the different aspects of the embodiments.

1-23. (canceled)

24. A system for recognizing wine bottles stored in a wine storage area and for obtaining information about the stored wine bottles comprising:
a plurality of wine bottle storage locations within a wine storage area;
at least one or more wine bottles stored in any of the wine bottle locations;
at least one optical detector adapted to generate image information that includes image data of a first wine bottle as it is being stored into, or removed from, the wine bottle storage location, and wherein the at least one optical detector is further adapted to output the image information as a camera output signal;
at least one processor communicatively coupled to the at least one optical detector; and
a memory operatively connected with the at least one processor, wherein the memory stores computer-executable instructions that, when executed by the at least one processor, causes the at least one processor to execute a method that comprises:
receiving, via the at least one optical detector, the camera output signal within a wine tracker application executing on the processor;
analyzing the camera output signal;
extracting a first set of wine information pertaining to the wine stored in the first wine bottle on the basis of the analysis of the camera output signal by the processor and wine tracking application;
capturing an image of a label of the first wine bottle in the camera output signal for the first wine bottle from the camera output signal;
extracting a second set of wine information pertaining to wine stored in the first wine bottle from the captured image of the label of the first wine bottle;
obtaining a third set of information electronically from one or more of a plurality of sources including commercially available wine information databases regarding the wine in the first wine bottle.

25. The wine bottle tracking system according to claim 24, wherein the method that is executed by the at least one processor further comprises:
extracting additional wine information from the first wine bottle by processing a label on the first wine bottle.

26. The wine bottle tracking system according to claim 25, wherein the method that is executed by the at least one processor further comprises:
performing optical character recognition processing on the label of the first wine bottle.

27. The wine bottle tracking system according to claim 25, wherein the method that is executed by the at least one processor further comprises:
performing image recognition processing on the label of the first wine bottle.

28. The wine bottle tracking system according to claim 24, wherein the method that is executed by the at least one processor further comprises:
generating a wine bottle identification (wine bottle ID) for each bottle of wine;
generating a respective wine database record for each bottle of wine that is tracked by the wine bottle tracking system;
storing the wine database record in the memory, wherein
the wine database record comprises any one or more of the first set, second set, third set, and additional wine information;
determining a storage location in the wine storage rack as the wine bottle is being stored;
correlating each wine bottle ID of a respective wine bottle with the storage location of the respective wine bottle; and
updating the wine database record for each new bottle of wine as it is stored into or removed from the wine bottle storage area.

29. The wine bottle tracking system according to claim 28, wherein
the wine database record includes a plurality of fields comprising at least a wine bottle identification field, a bottle location identification field, and a wine information identification field.

30. The wine bottle tracking system according to claim 29, wherein
the wine bottle identification field comprises a unique alpha-numeric identification for each respective wine bottle analyzed by the wine bottle tracking system, and wherein
the bottle location identification field comprises a unique alpha-numeric identification for each respective wine bottle that identifies its unique location within the wine storage area, and wherein
the wine information identification field comprises a unique alpha-numeric identification for a respective type of wine that includes a unique set of wine information.

31. The wine bottle tracking system according to claim 30, wherein
the bottle location identification field includes storage location information that uniquely identifies a specific storage location of a respective bottle of wine within the wine storage area.

32. The wine bottle tracking system according to claim 29, wherein the method that is executed by the at least one processor further comprises:
generating a plurality of additional fields in the wine database record, wherein
the additional fields include further additional wine-related information that is related to the wine stored in the bottle.

33. The wine bottle tracking system according to claim 24, wherein
the at least one optical detector comprises at least one of a low-resolution still camera, a high-resolution still camera, a low-resolution video camera, a high-resolution video camera, an infra-red camera, a stereovision camera, and a coherent light transmitter and receiver.

34. A method for recognizing wine bottles being stored in a wine storage area and for obtaining information about the stored wine bottles, the method comprising:
receiving, via at least one optical detector coupled to at least one processor, a camera output signal representing an image of a first wine bottle as it enters the wine bottle storage area, at a wine tracker application executing on the at least one processor, the wine tracker application stored in a memory associated with the at least one processor;
analyzing the camera output signal;
extracting a first set of wine information pertaining to the wine stored in the first wine bottle on the basis of the analysis of the camera output signal by the processor and wine tracking application;
capturing an image of a label of the first wine bottle in the camera output signal for the first wine bottle from the camera output signal;
extracting a second set of wine information pertaining to wine stored in the first wine bottle from the captured image of the label of the first wine bottle; and
obtaining a third set of information electronically from one or more of a plurality of sources including commercially available wine information databases regarding the wine in the first wine bottle.

35. The method according to claim 34, further comprising:
extracting additional wine information from the first wine bottle by processing a label on the first wine bottle.

36. The method according to claim 35, further comprising:
performing optical character recognition processing on the label of the first wine bottle.

37. The method according to claim 35, further comprising:
performing image recognition processing on the label of the first wine bottle.

38. The method according to claim 34, further comprising:
generating a first wine bottle identification (first wine bottle ID) for the first wine bottle;
assigning the first wine bottle ID to the first wine bottle; and
generating a first wine database record in the memory associated with the processor for the first wine bottle.

39. The method according to claim 38, further comprising:
determining a storage location in the wine storage rack as the wine bottle is being stored;
correlating the first wine bottle ID of the first wine bottle with the storage location of the first wine bottle;
generating a first wine information identification (first wine info ID) for the first wine bottle;
assigning the first wine info ID to the first wine bottle; and
adding the first wine info ID to the first wine database record.

40. The method according to claim 39, further comprising:
generating a first wine bottle location identification (first bottle location ID) for the storage location of the first bottle of wine; and
adding the first bottle location ID to the first wine database record for the first wine bottle.

41. The method according to claim 38, wherein
the first wine database record includes a plurality of fields comprising at least a wine bottle identification field, a bottle location identification field, and a wine information identification field, and additional fields, and wherein
the wine bottle ID comprises a unique alpha-numeric designator, and is stored in the wine bottle identification field,
the bottle location ID comprises a comprises a unique alpha-numeric designator, and is stored in the bottle location identification field,
the wine information ID comprises a comprises a unique alpha-numeric designator, and is stored in the wine information identification field, and wherein
the additional fields include additional wine-related information that is related to the wine stored in the bottle.

42. The method according to claim 34, wherein
the at least one optical detector comprises at least one of a low-resolution still camera, a high-resolution still camera, a low-resolution video camera, a high-resolution video camera, an infra-red camera, a stereovision camera, and a coherent light transmitter and receiver.

43. A method for recognizing wine bottles being removed from a wine storage area and for updating information about the stored wine bottles, the method comprising:
receiving, via at least one optical detector coupled to at least one processor, a camera output signal representing an image of the first wine bottle as it is removed from its respective bottle storage location in the wine bottle storage area, at a wine tracker application executing on at least one processor, the wine tracker application stored in a memory associated with the at least one processor;
obtaining updated wine information from a plurality of sources to verify pricing and availability of the wine in the wine bottle; and
updating a wine database record stored in the memory that the wine bottle has been removed from the bottle storage location and wine bottle storage area when the wine bottle is removed from the bottle storage area.

44. The method according to claim 43, further comprising:
verifying that the wine information obtained from the image of the label of the retrieved wine bottle matches the wine information stored in the wine database record as well as the wine bottle identification, bottle location identification, and the wine Info identification.

45. The method according to claim 44, wherein the step of verifying comprises:
determining a bottle storage location and a bottle location identification associated with the bottle storage location;
capturing an image of the label of the first wine bottle in the camera output signal for the first wine bottle;
obtaining a wine bottle ID from a wine database record for the bottle location identification;
obtaining the wine Info ID from the wine database record for the bottle location identification; and
analyzing the image of the label and obtaining wine information from the image of the label, and wherein the first wine database record comprises a plurality of fields comprising at least a wine bottle identification field, a bottle location identification field, and a wine information identification field, and additional fields, and wherein
the wine bottle ID comprises a unique alpha-numeric designator, and is stored in the wine bottle identification field,
the bottle location ID comprises a comprises a unique alpha-numeric designator, and is stored in the bottle location identification field,
the wine information ID comprises a comprises a unique alpha-numeric designator, and is stored in the wine information identification field, and wherein
the additional fields include additional wine-related information that is related to the wine stored in the bottle.

46. The method according to claim 43, wherein
the at least one optical detector comprises at least one of a low-resolution still camera, a high-resolution still camera, a low-resolution video camera, a high-resolution video camera, an infra-red camera, a stereovision camera, and a coherent light transmitter and receiver.

47-69. (canceled)
